(19) United States
(12) Patent Application Publication
(10) Pub. No.: US 2022/0274703 A1
(43) Pub. Date: Sep. 1, 2022

(54) Autonomous Inspection System within a Smart Self-Healing Node Centric Blockchain Network for Safety and Quality Management

(71) Applicant: Michele Di Cosola, Bloomingdale, IL (US)

(72) Inventor: Michele Di Cosola, Bloomingdale, IL (US)

(21) Appl. No.: 17/683,339

(22) Filed: Feb. 28, 2022

Related U.S. Application Data
(60) Provisional application No. 63/154,746, filed on Feb. 28, 2021.
(60) Provisional application No. 63/217,206, filed on Jun. 30, 2021.
(60) Provisional application No. 63/217,217, filed on Jun. 30, 2021.

(51) Int. Cl. B64C 39/02; G07C 3/14; G06V 20/17; G06V 20/10

(52) U.S. Cl. CPC B64C 39/024; G07C 3/14; G06V 20/17; G06V 20/176; B64C 2201/123; B64C 2201/141

(57) ABSTRACT

A system for providing an inspection system including an autonomous unmanned aerial vehicle (UAV) having the image capture device coupled together for generating image data used in inspections, a blockchain-based data exchange storage and verification device for maintaining image data, identified parts data, parts acquisition data, parts report data, and repair reports and corresponding repair data, a parts identifier, a parts identifier for generating one or more potential part identifications from the image data generated by the UAV, a parts acquisition installer, a repair reports generator for generating one or more repair reports based upon data stored within the blockchain-based data exchange storage and verification device, and a digital twin parts predictive fatigue and lifecycle maintenance estimator, the digital twin parts predictive fatigue maintenance lifecycle estimator for generating fatigue-based part life cycles for the one or more potential part identifications from the parts identifier. The parts identifier is an application programming interface to a remote third-party image analysis and component identification system. The parts acquisition installer schedules installation of a replacement part selected from the one or more potential part identifications from the parts identifier. The repair reports generator generates one or more repair reports based upon data stored within the blockchain-based data exchange storage and verification device. The digital twin parts fatigue maintenance estimator is an application programming interface to a remote third-party digital twin modeling and simulation-based parts fatigue and maintenance estimator.

### CROSS-REFERENCE TO RELATED APPLICATION

This application claims priority to U.S. Patent Application No. 63/217,206, titled “A Universal Computing Node in a Distributed Computing Environment,” and filed on Jun. 30, 2021, and U.S. Patent Application No. 63/217,217, titled “Low-Latency Blockchain Weather Data Exchange,” and filed on Jun. 30, 2021. This application also claims priority to U.S. Patent Application No. 63/154,749, titled “Artificial Intelligence Machine Learning AIML SMS SRM CRM QMS and Blockchain Cyber Security System for Unmanned Aircraft Vehicles UAV Systems,” filed on Feb. 28, 2021.

This application is also related to commonly owned and pending U.S. patent application Ser. No. 16/866,484, titled “Smart Drone Rooftop and Ground Airport System,” and filed on May 4, 2020, that itself claims priority to U.S. Provisional Patent Application No. 62/842,757, filed May 3, 2019 titled “Universal Automated Artificial Intelligence Rooftop UAS/UAV Drone Port/Airport Station For General Purpose Services Of Robotic UAS/UAVS, And Its Supporting Hardware & Equipment Related To: Loading/Unloading Deliveries, Deployment/Arrival, Dispatching, Air Traffic Control, Charging, Storing/Garaging, De-Icing/Anti-Icing, Meteorological & Data Dissemination/Retrieval, Big Data Mining And Mimo Network Services” and the U.S. Provisional patent application Ser. No. 17/187,871, titled “Smart City Smart Drone Uas/Uav//Vtol Mailbox Landing Pad” filed on Feb. 28, 2021, that claims priority to U.S. Provisional Patent Application No. 62/983,486, titled “Smart City Smart Drone Uas/Uav//Vtol Mailbox Landing Pad, filed Feb. 28, 2020.

This application is also related to concurrently filed and commonly assigned U.S. patent application Ser. No. ??/???,???, titled “A Universal Computing Node Within a Smart Self-Healing Node Centric Blockchain Network,” Attorney Docket No. RG2177.008-US-01, filed 28 Feb. 2022, and U.S. patent application Ser. No. ??/???,???, titled “A Data Exchange Within a Smart Self-Healing Node Centric Blockchain Network,” Attorney Docket No. RG2177.008-US-01, filed 28 Feb. 2022. All of the above referenced applications are incorporated herein as if recited herein in their entirety.

### TECHNICAL FIELD

This application relates in general to a system for providing data searching, data purchasing and rights management, and data acquisition, and more specifically, to a system for providing a drone based inspection system within a smart self-healing node centric blockchain mesh network having blockchain processing.

### BACKGROUND

Distributed processing systems in which applications are performed as smaller operating procedures across a number of processing systems over a geographic area have been growing in functions, complexity, and uses as individual processing systems increase capabilities when, at the same time, communications networks allow large amounts of data to be transmitted between these processing systems. This trend has given rise to a number of processing approaches including edge computing, mesh computing, Internet of Things (IoT), digital twin, metaverse, omniverse, and autonomous vehicles operating in a distributed controlled environment.

An evolution is occurring for autonomous and manual transportation for cargo and people via the next generation delivery infrastructure. The autonomous delivery infrastructure, soon to come, needs a commercially viable and sustainable solution to be successful. Simply relying on revenue from the delivery of people or cargo is not enough. Delivery service providers need to be able to have the public's buy-in to support the solution of autonomous drone and virtual take-off and landing (VTOL) delivery and therefore need to rely on the data that could make it happen. However, data to support beyond visual line of site (BVLOS) delivery was not trusted, was not cyber protected, did not have a chain of custody as to its original source and was easily spoofed and therefore had no resilience and or immutable solutions. If someone wanted to sell their data after personal use, it was not discoverable by others, and even if it was, it was not reliable, trusted data that can be repurposed and/or used in near real time for other operations after it has been validated as good data. More importantly, the infrastructure to make a bunch of smart drone airports from ground up to support true last mile logistics is cost prohibitive and would take years to develop, even though possible.

Currently being developed is a wide spectrum of how the autonomous infrastructure operate and mature into a commercially viable and sustainable model, while integrating into existing manual transportation fleet operations and building infrastructures. This infrastructure is evolving into a system that, in addition to operation of the unmanned aerial vehicles (UAVs), Vertical Take-Off and Landing Vehicles (VTOLs) Electric Vertical Take-Off and Landing Vehicles (eVTOLs), Hydrogen Vertical Take-Off and Landing Vehicles (hVTOLs), Unmanned Robotic Vehicles (UGVs) Delivery Robots, and similarly named, renamed and or soon to be named autonomous vehicles of people and cargo, includes a decentralized data exchange market maker of Layer Zero (L_0), Layer One (L1) State Channel(s) of agnostic types of data that is blockchain validated data as a service (BVDaaS), blockchain validated data storage as a service (BVDSaaS), data market maker as a service (DMMaaS), Directed Acyclic Graphs as a Service (DAGaaS), Node as a Service (NaaS), Proof of Reputation (POR) for Peer to Peer (P2P) validation of data consensus from the data's genesis, Hyper Graph Transfer Protocol as a Service (HGTPaaS) with Mainnet 2.0, Web3 as a Service (W3aaS), Crypto and Token Rewards as a Service (CTRaaS for meta and big data, 3D Parts on Demand as a Service (3DPDaaS), Layer Zero (L_0) and Layer 1 (L1) Network's Digital Data Bundle of Rights NFTs (Non-Fungible Tokens, NFRs (Non-Fungible Rights/NFBOR (Non-Fungible Bundle of Rights) for custom Smart Contract minted Tokens and NFTs/NFRs/NFBORs, that provide for a automated and custom Terms and Condition Agreements for the Data Supplier and the Data Acquisition User through their independent and customizable digital data bundle of rights dash board(s) and selected data exchange(s), as a scalable, interoperable, immutable, modular and multi-modal open source platform, for the autonomous infrastructure and beyond.

This infrastructure needs to be able to help digital assets such as metadata asset and property owners reclaim the skies as the first ever decentralized discoverable depository and repository data exchange, sub-exchange(s) and market maker of immutable resilient data for data suppliers and users of autonomous cargo and people transportation infrastructure. Creating a commercially viable and sustainable market by taking the real physical asset world and connects it to the digital data asset world by way of Utility, and dependability on each other using data, crypto, tokens, NFTs, NFRs, NFBORs, Data Exchange(s), digital twin, metaverse, and or omniverse, as a full turn-key solution for all participants. This provides for safety, blockchain & cyber security, and sustainability, through mining, securing, subsidizing and or monetizing the data.

Therefore, a need exists for a system for providing a distributed secure data exchange computing environment used to support autonomous devices having blockchain processing. The present invention attempts to address the limitations and deficiencies in prior solutions according to the principles and example embodiments disclosed herein.

### SUMMARY

In accordance with the present invention, the above and other problems are solved by providing a system for a distributed secure data exchange computing environment used to support autonomous devices having blockchain processing according to the principles and example embodiments disclosed herein.

In one embodiment, the present invention is a system for providing an inspection system having an autonomous UAV and an image capture device communicatively connected to a Layer zero (L_0) Layer 1(L1) and or (L2) distributed Peer to Peer (P2P) network(s) that are point to point, point to cloud, point to on premises (on prem) and or cloud to premises(on prem) with smart blockchain-based Proof of Reputation (POR) data consensus with a Directed Acyclic Graph (DAG), Hypergraph Transfer Protocol (HGTP), Web3, Mainnet 2.0, Layer 0 and Layer 1 State Channels, data exchange storage and verification device, with the option of Digital Data Bundle of Rights in a L_0 Non-Fungible Token (L-0 NFT), Layer 1 NFT, and Layer Zero (L_0) Non-Fungible Bundle of Rights (NFR or NFBOR), and one or more universal computing nodes within a self-healing, node-centric blockchain mesh network. The inspection system includes an autonomous UAV coupled to an image capture device for generating image data used in inspections, a blockchain-based data exchange storage and verification device for maintaining image data, identified parts data, parts acquisition data, parts report data, repair reports and corresponding repair data, a parts identifier, a parts identifier for generating one or more potential part identifications from the image data generated by the UAV, a part acquisition installer, a repair reports generator for generating one or more repair reports based upon data stored within the blockchain-based data exchange storage and verification device, and a digital twin parts fatigue maintenance estimator for generating fatigue based part life cycle for the one or more potential part identifications from the parts identifier. The parts identifier is an application programming interface to a remote third-party image analysis and component identification system. The part acquisition installer schedules installation of a replacement part selected from the one or more potential part identifications from the parts identifier. The repair reports generator generates one or more repair reports based upon data stored within the blockchain-based data exchange storage and verification device. The digital twin parts fatigue maintenance estimator is an application programming interface to a remote third-party digital twin modeling and simulation-based parts fatigue, maintenance, lifecycle, human interaction, and traffic flow management estimator. Once the part is identified and the order is placed, the parts can be made on-demand in both one-offs and multi-unit orders, with 3D Printing/Manufacturing facilities that have an available queue, the correct machine hardware and part materials and can meet the turn-around time and demand of the purchaser.

In another aspect of the present invention, the part acquisition installer comprises a parts acquisition controller, a parts availability locator that identifies available sources with estimated cost and expected delivery dates for the one or more potential part identifications from the parts identifier, a part criticality analyzer, a part compliance analyzer, a part cost analyzer, and a part internal manufacturer. The parts acquisition controller coordinates the interaction software components within the parts acquisition installer. The part criticality analyzer determines for one or more of the requested parts whether any critical issues in need of urgent and immediate attention are present and whether emergency report message requirements associated with the identified critical issues are necessary. The part compliance analyzer determines all repair reports that are needed in response to the inspection performed by a UAV 125 based upon the received information and all other available data. The part cost analyzer provides replacement part costs associated with every available source and delivery time required; the replacement part costs comprise all costs to deliver the selected replacement part in a specified timeframe. The replacement costs comprise a cost of the part itself, all delivery charges that may be incurred, any rush charges needed to obtain the replacement part by a specified date, and any costs associated with handling, storing, and installing each part to the extent they differ for different available parts.

In another aspect of the present invention, the parts acquisition controller is communicatively coupled to a parts acquisition database. The parts acquisition database provides a part data record, manufacturer and suppliers that includes cost and current availability, lead time to delivery, technical part design documentation, part IDs, equivalent parts from alternate manufacturers, and part 3D printing specifications to create each part. The parts acquisition database is stored within the blockchain-based data exchange storage and verification device.

In another aspect of the present invention, the parts availability locator is communicatively coupled to a parts characteristic database. The parts characteristic database provides a part characteristic data record that comprises data to identify possible manufacturer and suppliers that includes cost and current availability and lead time to delivery, to identify part IDs, and to identify equivalent parts from alternate manufacturers. The parts characteristic database is stored within the blockchain-based data exchange storage and verification device. All intellectual owners and providers of these works provided on the exchange, such as parts CAD designs, 3D images, data characteristics identifier suppliers, etc. are able to be tracked and compensated as to their participation, terms and conditions, based on their Digital Data Bundle of Rights (L_0 & L1 NFT, L_0 & L1 NFR, L_0 & L1 NFBOR) that have been used in meta data, raw data, fused data and or other forms of agreed distributed validated data to be used by the acquisition user.

In another aspect of the present invention, the parts criticality analyzer is communicatively coupled to a parts regulation database. The parts regulation database provides a part ID, a manufacturer and supplier, and one or more critical issue definitions associated with the requested part for use by the parts criticality analyzer. The parts regulation database is stored within the blockchain-based data exchange storage and verification device.

In another aspect of the present invention, the repair reports generator comprises a set of software components for generating a repair report. The set of software components includes a repair report controller that coordinates the interaction of the set of software components within the repair report generator, a parts report data retriever that retrieves data from the blockchain-based data exchange storage and verification device containing inspection and parts identification data used and generated within the repair report generator, a report compliance requirement processor that determines and provides all requirements associated with a repairs report to be generated from the data associated with the repair and inspection data stored in the blockchain-based data exchange storage and verification device, a repair report generator that receives repair report data obtained from the blockchain-based data exchange storage and verification device and creates the repair report, and a compliance report submitter that receives a completed and formatted repair report from the repair report generator with an identity of an agency server to which the completed and formatted repair report is to be submitted. Quantitative Data, Data, Compliance and or Resolution Reports, with regulation requirements for example, can comply with Artificial Intelligence Machine Learning (AIML) Safety Management Systems (AIML SMS), AIML Quality Risk Management (AIML QRM), AIML Quality Management Systems (AIML QMS), AIML Safety Risk Management (AIML SRM), AIML Quality Assurance (AIML QA), AIML Safety Assurance (AIML SA) and or Autonomous AIML Crew Resource Management Sensors (AIML CRMS).

In another aspect of the present invention, the report compliance requirement processor is communicatively coupled to a parts compliance report database that provides a part ID, a manufacturer and supplier, and one or more critical issue definitions associated with the requested part. The repair reports database is stored within the blockchain-based data exchange storage and verification device.

In another aspect of the present invention, the repair report generator is communicatively coupled to a repair reports database that creates the repair report using a specified report format defined within an agency data record stored in the repair reports database that is associated with an agency server that is to receive the repair report and the repair reports database creates the repair report using a specified report format defined within an agency data record stored in the repair reports database that is associated with the agency server that is to receive the repair report. The repair reports database is stored within the blockchain-based data exchange storage and verification device. Acquisition of such services, mining services and or distributed data procurement under custom digital data bundle of rights terms and conditions, can be made in any form, such as fiat, Fungible and Non-Fungible tokens, rights, crypto, stablecoin, social and online payment methods, digital wallet payment methods, credit cards, rewards, data barter, etc., with either zero gas fees and or micro and or custom transaction fees.

In another aspect of the present invention, the inspector system is used as part of a safety management system.

In another aspect of the present invention, the inspector system is used as part of a quality management system.

The foregoing has outlined rather broadly the features and technical advantages of the present invention in order that the detailed description of the invention that follows may be better understood. Additional features and advantages of the invention will be described hereinafter that form the subject of the claims of the invention.

It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features that are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

Referring now to the drawings in which like reference numbers represent corresponding parts throughout:

FIGS. 1a-b illustrates an example embodiment of a drone based inspection system within a smart self-healing node centric blockchain mesh network according to the present invention.

FIG. 2a illustrates a set of processing components used within a parts acquisition-installer of the inspection system according to the present invention.

FIG. 2b illustrates a set of processing components used within a repair report generator of the inspection system according to the present invention.

FIG. 3 illustrates a functional diagram of a generic computing system that may be used as part of a system for providing a distributed secure data exchange computing environment used to support autonomous devices having blockchain processing according to the present invention.

FIG. 4a illustrates the components of a universal computing node that may be used as part of a system for providing a distributed secure data exchange computing environment used to support autonomous devices having blockchain processing according to the present invention.

FIG. 4b illustrates a universal computing node for use in a distributed computing environment used within a data exchange for autonomous devices having blockchain processing according to the present invention.

FIG. 5 illustrates a data exchange validated data record that may be used as part of a system for providing a distributed secure data exchange computing environment used to support a system for providing a drone-based inspection system, and or a drone, VTOL, eVTOL, hVTOL, UGV and or Robot for autonomous delivery of people and or cargo system, and or a mobile device equipped with the hereinabove camera and software functions, within a smart self-healing node centric blockchain mesh network having blockchain processing, having data access and clearance rights, to the present invention.

FIG. 6 illustrates a set of universal node software components that may be used as part of a system for providing a drone-based inspection system within a mobile device equipped with the hereinabove camera and software functions and within a smart self-healing node centric blockchain mesh network having blockchain processing according to the present invention.

FIG. 7 illustrates a data exchange data record search server that may be used as part of a system for providing a drone based inspection system within a smart self-healing node centric blockchain mesh network having blockchain processing according to the present invention.

### DETAILED DESCRIPTION

This application relates in general to a system for providing trusted validated data searching, data purchasing and rights management, and data acquisition, and more specifically, to a system for providing a distributed secure data exchange computing environment used to support autonomous devices having blockchain processing with Proof of Reputation (POR), with Directed Acyclic Graph (DAG) on Mainnet 1.0, Mainnet 2.0, Web3.0, Industry 4.0, HGTP, Layer Zero, Layer 1, and Layer 2, State channel(s), NFTs, NFRs, NFBORs, Crypto, Tokens and other Agreements, Contracts and Fiat methods of payment and or social rewards, according to the present invention.

Various embodiments of the present invention will be described in detail with reference to the drawings, wherein like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

In describing embodiments of the present invention, the following terminology will be used. The singular forms “a,” “an,” and “the” include plural referents unless the context clearly dictates otherwise. As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. As used herein, the singular forms “a,” “an,” and “the” are intended to include the plural forms as well, unless the context clearly indicates otherwise.

It further will be understood that the terms “comprises,” “comprising,” “includes,” and “including” specify the presence of stated features, steps or components, but do not preclude the presence or addition of one or more other features, steps or components. It also should be noted that in some alternative implementations, the functions and acts noted may occur out of the order noted in the figures. For example, two figures shown in succession may in fact be executed substantially concurrently or may sometimes be executed in the reverse order, depending upon the functionality and acts involved.

The terms “individual” and “user” refer to an entity, e.g., a human, using a system for providing data searching, data purchasing and rights management, and data acquisition, and more specifically, a system for providing a distributed secure data exchange computing environment used to support autonomous devices having blockchain processing associated with the invention. The term user herein refers to one or more users.

The term “invention” or “present invention” refers to the invention being applied for via the patent application with the title “Autonomous Inspection System within a Smart Self-Healing Node Centric Blockchain Network for Safety and Quality Management.” Invention may be used interchangeably with autonomous inspection system.

The term “mobile application” refers to an application executing on a mobile device such as a media player, set-top box, smartphone, tablet, and/or web browser on any computing device.

The term “application programming interface” that is also referred as “API” refers to a computer programming construct permitting a computing process running on a particular computing device to access software and related operations provided by a third-party running on a separate computing device using a standardized interface and data exchange format. The use of APIs to access third-party software permits development of collaborative computing products in which software components from different sources operate together to implement a processing solution.

The term “unmanned aerial vehicles (UAV)” refers to any embodiment of an UAV device. These UAV devices may include, but are not limited to: vertical take-off and landing vehicles (VTOL), electronic vertical take-off and landing vehicles (eVTOL), hydrogen unmanned ground vehicles (hVTOL), unmanned ground vehicle (UGV), unmanned aerial systems (UAS), vertical short take-off and landing vehicles (VSTOL), short take-off and landing vehicles, (STOL), electric small take-off and landing vehicles (eSTOL), conventional take-off and landing vehicles (CTOL), electric conventional take-off and landing vehicles (eCTOL), autonomous vehicles (AVs), connected and autonomous vehicles, cargo air vehicles (CAV), electric cargo air vehicles (eCAVs), passenger air vehicles (PAVs), hydrogen unmanned vehicles (HUV), hydrogen and electric unmanned vehicle hybrids (HEUVH), delivery robots, and electric passenger air vehicles (ePAVs).

The term “Autonomous Transportation System of Systems,” may include but is not limited to unmanned traffic management (UTM) fleet operations, and drones/UAVs/UGVs/Robots, smart landing pads, smart charging stations, smart droneports/drone hangers, smart drone rooftop and ground airports/vertiports, smart containers, smart mailbox landing pads, sensors, nodes, crypto, tokens, mining, AI, ML, ATC, Cyber Security, NFTs, NFRs, NFBORs, Validated Blockchain, Node Centric Mesh Networks, DAG, Mainnet 2.0, HGTP, Web3, Digital Wallets, Weather Reports, Operation Planning and Clearances.

The term “UTM fleet operations” refers to a UTM fleet operations traffic management system for stakeholders who manage their own fleets of autonomous vehicles, who will be able to protect their data by being onboarded and integrated into the UAV network. Existing UTMs provide data that cannot be reused with trust by another interested third-party. There is no way to let third parties know what data is currently available that can be repurposed for use from one or more of data exchange(s) and or sub-exchanges disclosed herein. The present invention provides an interoperable, horizontally data and hardware scalability with node proof of reputation (POR) consensus, DAG, HGTP, and Mainnet 2.0, that has vertical scalability, is modular, multi-modal, immutable, resilient, open software platform in which UTMs can capture the value of this data both for their company and their clients.

The term “drone/UAV providers” refers to robot and manual vehicle manufacturers with sensors such as light detection and ranging (LiDAR), radar, and weather sensor payloads that provide situational awareness, object detect and avoid, terrain avoidance, autonomous decision making, adverse weather avoidance, weather operation planning, and beyond visual line of site operations (BVLOS), either because there is a governing body mandate and/or for an added feature for an additional data solution. Very few existing autonomous delivery transportation stakeholders can sustain the cost of R&D, manufacturing, maintenance, and delivery without continual large cash infusions, which makes the existing models not commercially viable and sustainable without a method by which to offset those costs.

The term “data exchange” refers to a data storage device that stores data received for long term usage onto a blockchain ledger using blockchain processing, with features such as but not limited to interoperable and agnostic data, DAG, HGTP, Layer Zero (L_0), Layer 1 (L1), and Layer 2 (L2) networks, Web3, Mainnet2.0, digital wallet, fiat, crypto, tokens, NFTs, NFRs, NFBORs, and other Non-Fungible Tokens, nodes, state channels, etc., where data is aggregated by automated upload in near real time stream and or manual upload. The data ledger is maintained on a plurality of universal computing nodes as is common in all blockchain processors. These computing nodes are disclosed herein as being interconnected over a distributed computing network using standard data communications protocols. One skilled in the art will recognize that the blockchain ledgers being maintained by multiple universal computing nodes also may be implemented with other comparable communications and secure storage technologies including L_0 (level zero) distributed network, HGTP (hypergraph transfer protocol) network, and any other network configuration and protocol.

The term “L_0 distributed network” refers to existing cryptocurrency token standards and decentralized layer 1 protocols such as Ethereum (ETH) and DISC which have high slow latency and vastly fluctuating and high gas fees (transaction fees) to use their networks. The historic data cannot be created at its original source because the data validators in ETH are not providing the full historic blockchain data creation events, when using Proof of Work (PoW) and Proof of Stake (PoS) metrics, which contributes to the high gas fees and latency associated with the various networks. Using this older method, the business models' cost and profit predictability become uncertain for DISC and ETH to produce commercially sustainable and viable blockchain validated and trusted data such as that provided by using our smart self-healing node centric mesh network, Autonomous Data Infrastructure, and the DEX/AMX Data Exchange and Sub-Exchange Data Exchange(s).

This high data latency fluctuation and gas fee dilemma can be solved by a system minting an L_0 token using an HGTP hypergraph network that is a decentralized layer zero (0) protocol and network, which requires zero transaction fees, built as a high-volume transaction utility and use cases, with lower latency and scalable solutions. The hypergraph network is built with concurrent consensus mechanisms and is structured using a directed acyclic graph for high bandwidth and throughput needs, thereby allowing for the creation of a scalable business model and metric on top of the hypergraph by attaching a transaction fee to various products, services, and solutions without the cost of layer 1 transaction fees. A crypto user base customer who entered the data exchange(s) and the hypergraph network, out of layer 1 networks like ETH, will be able to navigate through the DISC, and similar networks, and the hypergraph network and associated DEX, AMX, its Sub-Exchange(s) and lattice exchanges and state channels.

The term “data redefined” refers to creating a commercially viable and sustainable autonomous infrastructure. The present invention introduces a disruptive method by which to evolve the existing manual aviation and vehicle aviation structure and economics into a redefined data structure that will take existing cost-affordable sensors and integrate them into an autonomous system that can be sustained through the use, subsidization, and monetization of trusted, immutable, resilient, genesis validated, chain of custody and memorialized data that will reward good data suppliers and will volt bad data suppliers, while creating a market maker environment between data suppliers and data acquisition users. The present invention has created a solution of repurposing of roofs, land, mailboxes, and trusted data exchanges for the autonomous infrastructure. This architecture must include at minimum, but not be limited to, a system that is data agnostic, data repurposed, Data Depository and Repository, Rooftop and Ground Space Repurposed, Mailboxes and Parcel Mailboxes Repurposed as Smart Mailbox Landing Pads, Real Estate Bundle of Rights, Own the Air Around You with Metadata, Digital Data Bundle of Rights©, Discoverable Data with Integrity, Live Data Repurposed, Historic Data Repurposed, Existing Infrastructure Repurposed, digital twins, metaverse, omniverse, and non-fungible tokens (NFTs), Non-Fungible Bundle of Rights: NFRs & NFBORs, non-fungible tokem.

The term “data agnostic” refers to allowing for all types of industry accepted data formats to be universally accepted in the node network. The smart self-healing node centric blockchain network offers a delivery drone app, digital wallet, crypto, token, rewards and data exchange that is hardware/software agnostic on an interoperable, scalable, and open platform.

The term “data repurposed (repurposed data)” refers to taking existing data that has been used for its purpose and/or stored for memorialization and repurposing it to be sold on a discoverable data exchange for subsidization and/or monetization of hard and soft costs.

The term “Data Depository and Repository” refers to assigning data to be used for something other than its original purpose by uploading via automated and or manual live stream and or physical upload after use of the data into a data storage depository or repository for future monetization. Repurposed data means one time, recurring, profit sharing, and or residual income opportunities.

The term “Rooftop and Ground Space Repurposed” refers to residential, commercial, industrial rooftops and parking spaces that can be repurposed as a part of the autonomous infrastructure. By repurposing existing and previously worthless rooftop and ground space, the smart self-healing node centric blockchain network creates a multi-modal autonomous infrastructure consisting of nodes (machines, sensors, drones, landing pads, charging stations, VTOLs, UGVs, robots, etc.) necessary to create True Last Mile Logistics© and fill the data gaps that government and existing airport waypoints cannot fulfill. Using existing rooftops and ground infrastructure, the system can create raw data and or daisy-chained fusion weather, telemetry and other meta data use data points, delivery waypoints and smart drone, VTOL and UGV True Last Mile Logistics© airports by using existing unused and once worthless real estate.

The term “Mailboxes, Parcel Mailboxes, and “Smart Delivery Doorbells and Door Chimes” Repurposed” as “Smart Mailbox Landing Pads™” and Smart Landing Pads©, refers to repurposing existing federal-regulated mailboxes to integrate a Smart Mailbox Landing Pad™ into an existing shipping logistics infrastructure that can provide point-to-point blockchain validated AIML edge computing, IoT, point-to-point, point-to-on prem(premises), point-to-cloud-to-prem, cloud-to-prem, and or point-to-cloud communications. Smart Mailbox Landing Pads™ create delivery waypoints for customers. Smart Delivery Doorbells & Door Chimes© provide for but is not limited to ringing and custom ring tones, push notifications, shipping ordering, video and audio communications via doorbell, and other mobile devices, custom notifications, tracking, monitoring, confirmation of delivery, ambient weather conditions and times, photos, videos, recording, interior air quality sensors, bar code reading, surveillance, motion detection and activation, security, facial recognition, and or metadata that can be secured on chip and or on cloud for that specific location of departure, en route and or arrival locations on the network. The smart self-healing node centric blockchain mesh network can close the loop of a full turn-key utility autonomous drone, vehicle, and robot delivery process. This will also allow for existing manual operators to benefit from avoiding the grounding of their planned flight operations by taking existing node data from the departure waypoint, enroute waypoint and arrival waypoint of the landing pad, and figure out how to avoid any adverse weather being reported as Instrument Meteorology Conditions (IMC) on a User Interface (UI) and or User Experience (UX) weather graphical interface, fusion data and or weather swath from an existing sensors to maintain operations without grounding the vehicles.

The term “Own the Air Around You with Metadata” refers to users controlling the metadata produced and offering it under specific digital data bundle of rights terms and conditions set forth by the data supplier, in the data user backend dashboard and data acquisition user's back end dash board, using fiat and or with crypto and token rewards and or by participating in gamification programs.

The term “Digital Data Bundle of Rights©” refers to the digital data bundle of rights that provide for custom rights and or privileges that can be divided by use, terms, and ownership, among other privileges and rights. The present invention provides for a back-office dashboard where a data supplier can provide data that is assigned specific terms that will allow for a data acquisition user to agree to. For example, a data supplier may upload an NFT and state that a 72 DPI image can be purchased outright for a certain price but a 300 DPI is only available by lease for a limited time. That same file can provide for the option to buy the data as HD quality, but only if it is used for a digital twin project that will provide for royalty licensing rights. The file also can provide for fractional ownership of the NFT if it is 1200 DPI. The data supplier could even reserve anything that is 600 DPI for a charitable donation and still use the same 600 DPI as only available as a touch point licensing on IoT-only hardware. The data supplier can further expand on their terms and conditions by providing the same data with the same terms or different terms on a different data Sub-Exchange and or Multiple Sub-Exchanges. Determining the Digital Data Bundle of Rights© for terms and conditions of the digital data use and or ownership will be limited to the imagination and capability of the data and data supplier. The dashboard will be scalable as the terms evolve. The type of data and or use of data is agnostic and interoperable. Any data is monetizable or can be provided for free: dynamic and or static data, data types, files, formats, video, audio, communication frequencies, spectrums, etc.

The term “Discoverable Data with Integrity” refers to blockchain validated data that may be trusted as reliable data because it can be traced to its genesis originated by its original data supplier and throughout the sales and use process through a data exchange, which provides for the chain of custody and chain of events of the data from its genesis. This data is validated through a Proof of Reputation (POR) of Node Validator(s), that understands the reputation of the data and its source between nodes and provides for a consensus of this data to be trusted in a Zero Trust environment. This Discoverable Data with Integrity© allows for the purposing and repurposing of trusted data as a service.

The term “Live Data Repurposed” refers to the use of live data that has no purpose to be saved or is saved by live and on edge simultaneously for is intended purpose but is being bifurcated to also be repurposed on the data exchange for subsidization and monetization.

The term “Historic Data Repurposed” refers to using historic data that has no purpose other than to be stored for future review and to be saved if and until then, to be repurposed on the data exchange for subsidization and monetization.

The term “Existing Infrastructure Repurposed” refers to using existing commercial building structures, industrial building structures, municipality structures, military building structures, office building structures, residential structures, postal delivery structures, land, and transportation infrastructures for the newly created autonomous infrastructure to be ecofriendly.

The term “Digital Twins” refers to the digital twin model engine including but not limited to, predictive analytics, life cycle(s), route optimization, energy savings, ROI predictabilities, construction streamlines and outputs, production, simulation, metaverse, omniverse, virtual reality (VR), mixed reality (MR), augmented reality (AR), artificial intelligence (AI), machine learning (ML), and or fusing of user's data, that can be raw meta data and or big data fused to be seen and used through a user interface (UI), providing a user experience (UX), that will offer it to subsidize and or monetize that value of it via the Data Exchange (DEX), Autonomous Mobility Data (AMX) Exchange and or its Sub-Exchange(s) as markets start to understand the value of this digital data.

The term “metaverse” refers to an artificial digital environment that will provide for entire cities, small size-towns, countries, and worlds. Able to provide methods to sell products, services, advertising and or data. This can be sold on the DEX and AMX data exchange.

The term layer zero, layer one, or layer two, “non-fungible tokens” (NFTs), refers to digital instruments that will allow for data suppliers and data creators to take their data that would normally be tossed away after an inspection, surveillance, or delivery, for example, and either static data and or dynamic data that would either direct stream the data into the exchange database depository or repository and “purpose” the raw validated data and or “repurpose” the raw and or modeled verified data, to be used within the data exchange. As data producers and suppliers start to develop photo images, videos and or models, such as digital twin cities, that they wish to sell, lease, grant, gift, and or license, among the options of custom terms and conditions, but have decided to declare it as an original, unique, and one-of-a-kind digital data work product, that they will not reproduce as a digital asset, they will be able to do so via the NFT portion of the exchange.

The term layer zero, layer one and or layer two interchangeable names of “NFT Bundle of Rights (NFTBOR)” “non-fungible bundle of rights (NFBOR)” or “non-fungible rights (NFR)”, refers to taking a piece of that NFT, NFR and or NFBOR bundle for various uses. For example, users may want to keep the use of the land but sell the mineral rights. Users may want to lease the land itself. Users may also want to sell airspace. If a user has declared an original digital data as something the user will not reproduce and want it to be sold as an NFT, that data is the user's property to do with it as he/she would any piece of real estate based on the terms and conditions agreed to and received. However, old NFTs simply allow for the data to be sold off in pieces under smart contracts with fractional or full token share sales and purchases. A user could take a digital photo for example and offer it for sale, lease, gift, grant, loan, royalty, option, balloon and or license, based on the custom terms and conditions. Users can take that even further by saying that the NFT can be free to the public for one purpose and or use but must be purchased for another use and leased for even another. Users can even make them options and/or licensing rights with a balloon expiration date. This maximizes the NFT monetization opportunity to its fullest. There is no limit to the types of digital data one can use as an NFT, NFR, NFBOR and declare as a NFTBOR digital asset.

The term “open platform and interoperable sensor participation” refers to data fusion between data sets of diverse sensor data that will be possible as data sensor nodes that are on an layer zero (L_0), and or layer one (L1) network and or state channels, which are mining and validating on the data exchange that are onboarded. Users can add to their existing raw data and or model data by purchasing, leasing, and licensing the data as a layered solution for their new value-added data offered on the exchange.

The term “near real time data” refers to allowing universal computing nodes to be able to have a consensus between each other using a decentralized and distributed validation solution.

The term “historic data repository” refers to a storage location in which historic data can be submitted as a repository on the data exchange to provide for a data storage solution on edge, cloud and or on premises.

The term “discoverable data” refers to data integration and aggregation allowing for data depositories and repositories to be managed, to be discoverable, and to be accessible through an industry-specific data exchange query.

The term “Discoverable Trusted Verified Data with Integrity” refers to data exchange(s) combined with a hypergraph and digital wallet, that will be an agnostic range in data formats, and uses, but is not limited to, live data, raw data, modeled data, historic data, static and dynamic data, digital twin data, metaverse data, digital data bundle of rights such as non-fungible tokens (NFTs), non-fungible token bundle of rights (NFTBOR), non-fungible rights (NFR), non-fungible bundle of rights (NFBOR), minted tokens, crypto, telemetry data, remote data, stand-by data, and the like. The smart self-healing node centric mesh network takes into consideration the following when creating an exchange for your data. This data has integrity data, immutable data, resilient data, data chain of custody and memorization of events, data subsidization and monetization, sensors, smart shipping container and nodes, directed acyclic graph, hypergraph transfer protocol, Mainnet 1, 2 and beyond, Testnet 1, 2, and beyond, State Channel(s), L_0, L1, L2 distributed network.

The term “integrity data” refers to data that has been blockchain validated to its original source as encrypted trusted data.

The term “immutable data” refers to smart contract blockchain encrypted data.

The term “data chain of custody and memorization of events” refers to each block of data mined, horizontally blockchain validated and directed acyclic graph (DAG), encrypted, and monetized with a smart contract and data validation by proof of reputation, but can work with PoW and PoS networks. Allowing for all data to be tracked through a chain of custody via blockchain validation, to provide for the data's original genesis source, where it is and where it has gone permits the creating data supplier to always know where their data is and be compensated for its use.

The term “data subsidization and monetization” refers to trusted, blockchain-validated data that can be created for the purpose and or the repurpose to be sold on the DEX Exchange, AMX exchange and its Sub-Exchange(s) to subsidize and or monetize the data, via traditional credit, fiat, crypto and or token, and token rewards.

The term “smart shipping container and nodes” refers to autonomous air, ground and marine vehicles that will eventually be required to monitor and log all internal and external activity related to a transported container for safety and security. Containers come in all shapes and sizes. The smart self-healing node centric mesh network looks as these transportation multimodal opportunities to evolve the containers into Smart Shipping Containers©, Smart Cargo Containers©, Smart Drone Containers©, Smart Truck Containers©, Smart Train Containers©, Smart VTOL Containers©, Smart Marine Containers©, Smart Boat Containers©, Smart Car Containers©, Smart Travel Containers©, etc., that allow for security, security risk assessment, situational awareness, content monitoring, observation and memorialization using sensor data both inside and outside of the container. The container business will need to evolve with edge, point-to-point, point-to-cloud, and cloud to on premises data availability.

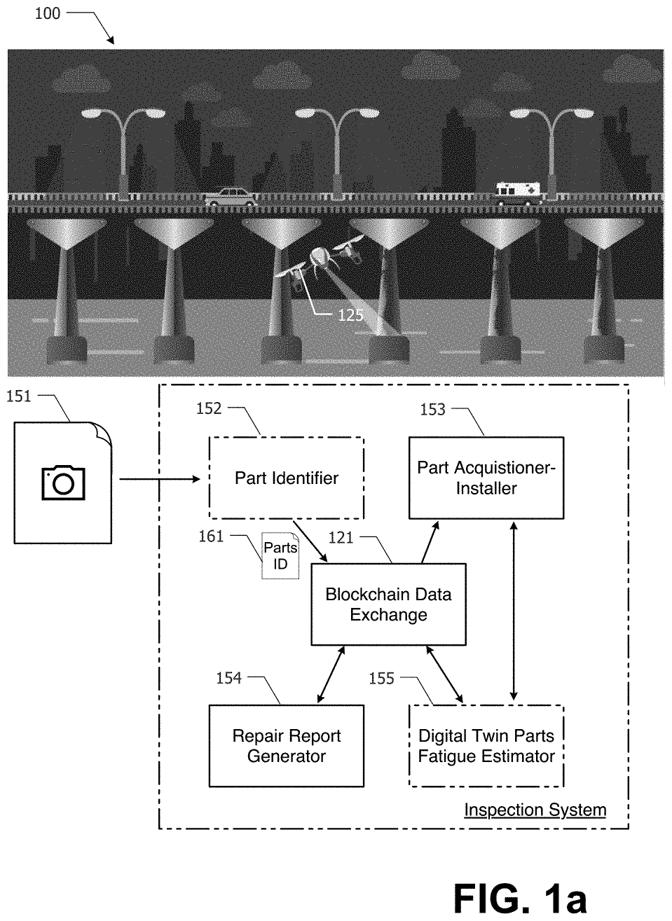

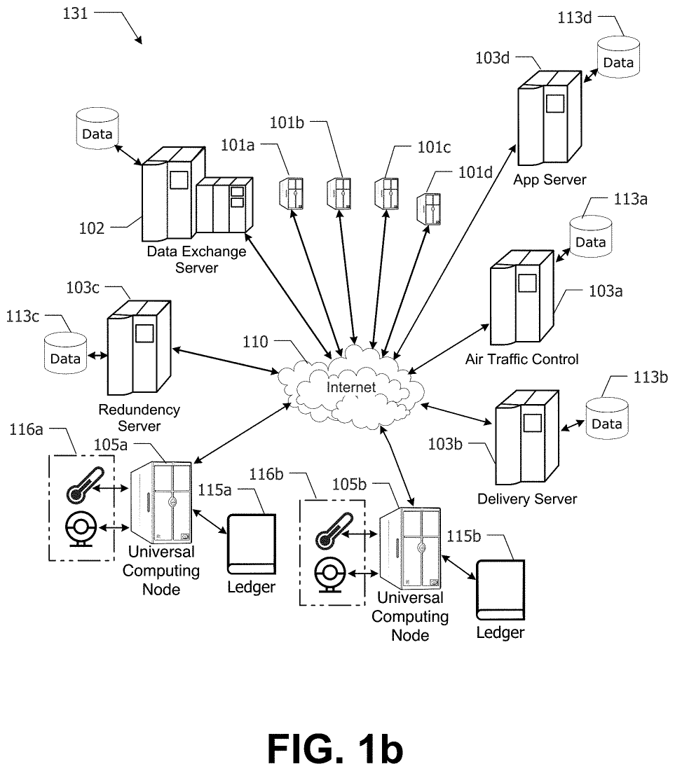

In general, the present disclosure relates to a system for providing a distributed secure data exchange computing environment used to support autonomous devices having blockchain processing according to the present invention. To better understand the present invention, FIG. 1a illustrates an example embodiment of a drone based inspection system within a smart self-healing node centric blockchain mesh network. The inspection system 100 utilizes an autonomous UAV 125 to obtain image data 151 of objects to be inspected with the additional computing components of the inspection system automatically performing the analysis and inspection review. The results of the inspection may result in notification of the results to relevant parties. The results of the inspection also may generate a service request which may include ordering and/or manufacturing of any necessary part(s) to be used in any maintenance and repair operations. Additional reporting of the results and notice of the status and completion of any repairs may be automatically generated for relevant parties including submission to required regulatory bodies and relevant parties.

The inspection system 100 comprises a set of processing components that operate to perform the processes used to perform the inspection and maintenance/repair operations as needed. The set of processing components 152-155 include a parts identifier 152, a parts acquisition-installer 153, a repair report generator 154, and a digital twin parts predictive fatigue and lifecycle estimator 155. Each of these components may be contrasted by one or more software components executing on a universal computing node 105a with a smart self-healing node centric blockchain mesh network as described within the universal computing node patent application referenced above.

The data used within the inspection system 100 includes all images 151 received from a UAV 125, the input and output data used by the set of processing components 152-155, logs of inspection, parts identification and ordering, and installation events, inspection and repair reports generated and provided to relevant parties, and all other data that may be utilized at a later date maintained within a secure data exchange 121 as described in detail in the data exchange patent application referenced above. Use of the data exchange 121 for data storage provides the inspection system 100 and its users all of the functionality of the data exchanges described therein.

The parts identifier 152 performs image analysis upon the image data 151 received from a UAV 125 to identify one or more parts within the image data. The identified parts may be returned with the identification of one or more possible parts that correspond to the object within the data image 151. Each of the possible parts may comprise manufacturer name and address, manufacturer part number or ID, sources available to provide a replacement part, the expected time for delivery and estimated cost when ordered, and any other relevant characteristics of the part. The other characteristics may comprise identification of category and status data associated with regulatory review of the replacement of the part, the criticality of replacement of the part with respect to the continuing use of the inspected item, and environmental and safety considerations associated with the part.

Because the parts identifier 152 may return more than one possible identified part, the parts identifier also any provide a match indicator or ranking of the likelihood that the item identified from the image data 151 corresponds to the identified part. Using this match indicator, the inspection system 100 may determine the part to be acquired and replaced as a result of the inspection.

The parts identifier 152 may be implemented using an API to access a third-party image recognition system that uses geometric or similar image identification techniques. One of many examples of an API system to access in image recognition system may be provided by the Physna Corporation of Columbus, Ohio. Details of the image recognition system may be found at www.physna.com.

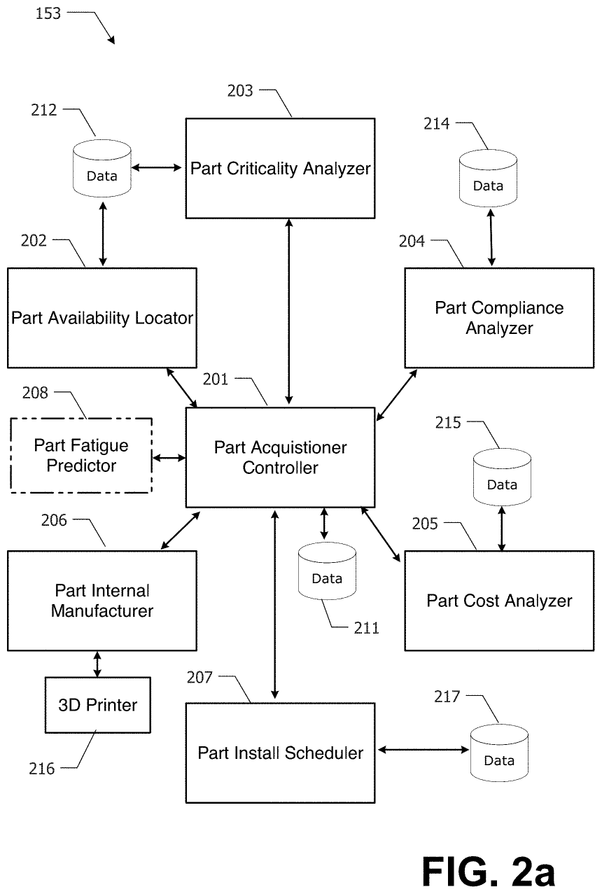

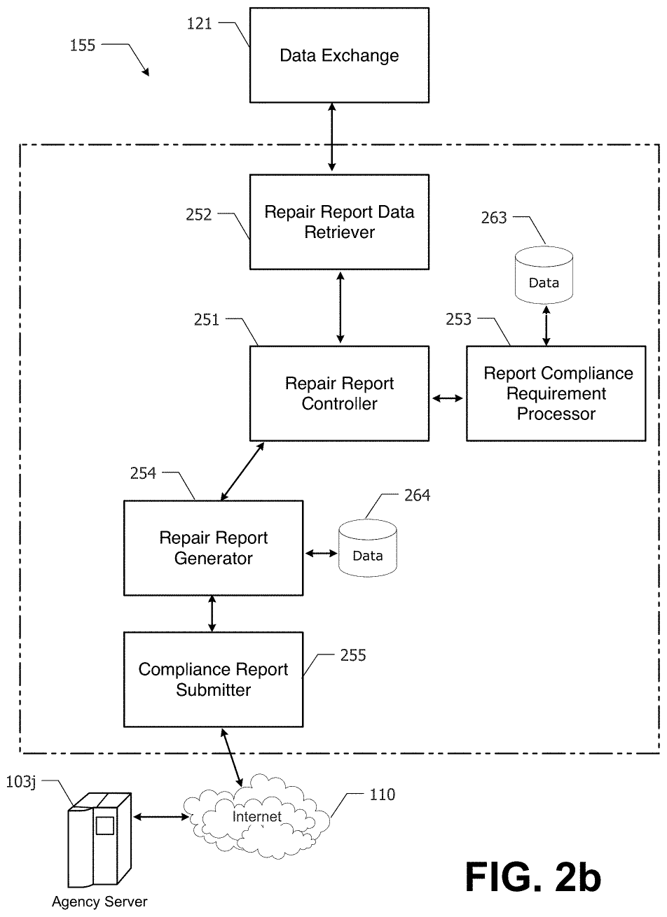

The parts acquisition-installer 153 receives information identifying one or more parts to be obtained in response to an inspection performed by a UAV 125. The parts acquisition-installer 153 is responsible for determining the availability, cost, and time needed to complete a repair based upon the received information and all other available data. The parts acquisition-installer 153 provides available sources for the parts to a user or may automatically submit an order for acquisition of the part depending upon the need, cost, availability, and any other factor. The parts acquisition-installer 153 may schedule the installation of the part based upon the availability of work crews and personnel to perform the repair and the expected availability date of the parts as determined by the parts acquisition-installer 153. The parts acquisition-installer 153 is described in detail in regard to FIG. 2a below.

The repair report generator 154 retrieves data from the data exchange to generate and transmit a report to an interested party regarding an inspection, repair, and condition of items of interest. The reports generated by the repair report generator 154 may include a simple email to a list of parties regarding the status and results of a particular inspection. For example, the repair report generator 154 may generate and send an email, text and or SMS, indicating a finding of a critical condition of an inspected item that requires immediate action to maintain safety and prevent injury and damage to the item and others that may occur given the identified critical condition. This email may be short and provide hyperlinks to additional data to be retrieved as needed.

The repair report generator 154 also may prepare and submit a report of the results of a required inspection including a description of any repairs needed and completed in response to the inspection to a governing regulatory agency or corporate entity. For many items that are typically inspected for safety and maintenance reasons, a report is required to be maintained and/or submitted to a particular governing regulatory agency or corporate entity in a specific report format in order for the item to comply with controlling regulations of the inspected item for safety of workers and the public-at-large. These reports may be required to be submitted using particular forms containing data specified in the controlling regulations. These reports may be needed to satisfy regulatory requirements of various jurisdictions such as federal, state, and local agencies, each of which may require the data using its own report format. The repair report generator 154 can generate these reports from the data obtained from the data exchange formatted according to the appropriate report requirements and submitted automatically to an agency server 103j according to a specified timeline to comply with the reporting requirements of the agency. Details of the operation of the repair report generator 154 is described in detail below in regard to FIG. 2b.

The digital twin parts predictive fatigue and lifecycle estimator 155 may be implemented using an API, SDK and or firmware to access a third-party digital twin modeling and simulation system that uses part fatigue and maintenance simulation techniques. One of multiple examples of an API system to access an image recognition system may be provided by Ansys, Inc. of Canonsburg, Pa. Details of the image recognition system may be found at www.ansys.com.

FIG. 1b illustrates an example embodiment of a distributed computing environment containing a system for providing a drone based inspection system within a smart self-healing node centric blockchain mesh network having blockchain processing according to the present invention. The inspection system 100 communicatively couples a plurality of universal computing nodes 101a-d and 115a-b to a set of servers including a data exchange server 102, an air traffic control server 103a, a UAV delivery server 103b, an app server 103c, a node redundancy server 103d, and other relevant servers as part of a smart self-healing node centric blockchain mesh network 101. The universal nodes 101a-d and 115a-b are described in detail in the previously referenced concurrently filed US patent application. The air traffic control server 103a, a UAV delivery server 103b, an app server 103c, a node redundancy server 103d, and the data exchange server 102 also are described in detail in the above US patent application. The delivery server 103b performs package pickup and delivery dispatch services including logging the UAV flights and deliveries as well as working with the air traffic control server 103a for flight trip route planning, in-air flight monitoring, and related air traffic control operations. All of these examples are associated with an example embodiment of a data exchange according to the present invention.

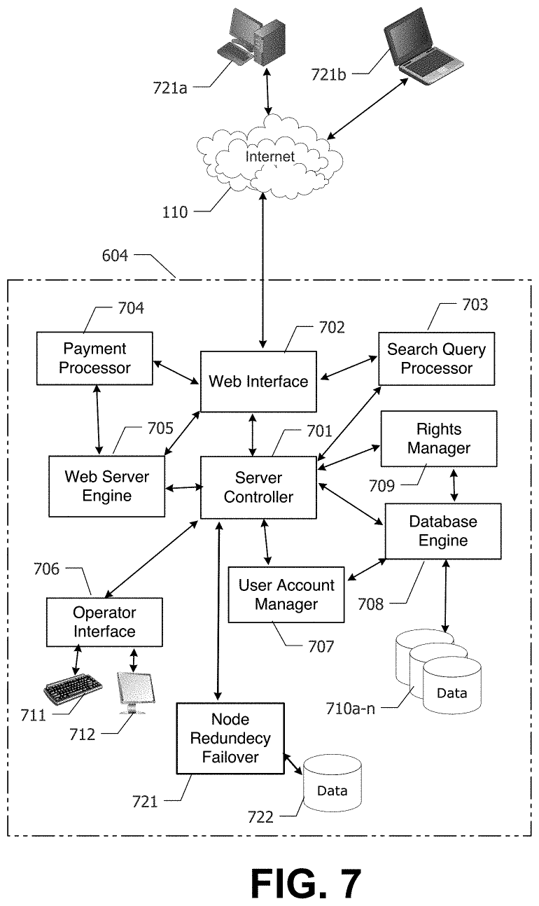

The universal computing nodes 105a-b are shown having a plurality of attached sensors 116a-b that generate data to be validated and included within the data exchange. The validated data is stored within the blockchain ledgers 115a-n that can be searched by users as described herein in reference to FIG. 7 below. If one sensor is no longer functioning or is providing below minimum healthy and functional reading requirements, a spare sensor will take over by data dumping the data and codes to the stand-by on board and or remote spare sensor.

One example of the benefits of a decentralized data exchanges can be demonstrated in aviation as it relates to weather and flight planning. Existing weather sensor data is relied upon by public and private sector airports and aviation pilots throughout the world. However, there are data gaps between airports that do not allow for pilots to confidently rely on their flights to have accurate weather and situational awareness beyond the sensor's existing distributed data distance capabilities. This leaves the burden of adverse weather mitigation up to the pilot to differentiate between what might be a life-threatening situation that may be too late to divert from without adequate notice. Additionally, most drones are authorized to fly from surface (AGL) to 400 feet. Satellite capabilities lose strength and reliability between 3000-5000 feet from the surface.

The redundancy server 103c controls and communicates with all of the universal computing nodes 101a-d, 105a-b on the smart self-healing node centric blockchain mesh network 131. The redundancy server 103c may detect a soon to fail or a failure of an active universal computing node 105a from a failure to respond to communications with any other universal computing node in the smart self-healing node centric blockchain mesh network 131. The redundancy server 103c also may be informed of a failure of one or more components, including sensors, by an active universal computing node 105a on the smart self-healing node centric blockchain mesh network 131. Whenever a failure occurs, the redundancy server 103c determines the sensors attached to the universal computing node 105a that has the failure as well as determines the functions performed by this universal computing node 105a within the smart self-healing node centric blockchain mesh network 131.

With this information, the redundancy server 103c identifies other universal computing nodes 105b within the smart self-healing node centric blockchain mesh network 131 that may replace the functionality of the failed computing node and coordinates the failover of the existing functions of the failed computing node to its replacement node. This failover may include transferring any data stored within the failed node to the replacement node The failover also may include transmitting a message to one or more universal computing nodes and servers on within the smart self-healing node centric blockchain mesh network 131 that the failover is occurring. The other nodes within the smart self-healing node centric blockchain mesh network 131 may update their configuration data to address all data requests and related communications that had been assigned to the replacement computing node. As such, the entire smart self-healing node centric blockchain mesh network 131 continues to operate after a brief failover as if the failure had not occurred.

It should be noted that the present invention uses data exchanges disclosed within the commonly assigned US patent application referenced herein to store all of the data found on each universal computing node in the preferred embodiment. As disclosed herein, the data exchanges utilize a blockchain ledger 115a to store this data for retrieval upon request. Because a blockchain ledger 115a automatically transfers all blockchain records 500, as described below, to multiple universal computing nodes to be added to multiple copies of any particular blockchain ledger 115a, and because a blockchain record 500 is not included into a blockchain ledger 115a until the inclusion of the record has generated a matching blockchain checksum or similarly computed value generated from the addition of the record to the ledger, very little data is expected to be transferred from a failing computing node to its replacement node as part of the failover process. Data redundancy and availability is automatically maintained by the smart self-healing node centric blockchain mesh network 131 with the use of the blockchain ledgers.

The redundancy server 103c may maintain a failover database 113c that contains rules for how particular node failures are to be handled. These rules may be specified for each individual universal computing node within the smart self-healing node centric blockchain mesh network 131 or may be specified by groups of similarly functioning universal computing nodes as appropriate. The redundancy server 103c may generate messages to system operators, node and data exchange owners, and any other interested party to inform these individuals of the failover event. The transmission of these messages may initiate a service request for maintenance and repair of the universal computing node that has caused the failover event.

The delivery server 103b provides external users to access the system 100 to request and schedule the services of a UAV 125 to perform a flight on their behalf. With respect to the inspection system 100, the delivery server 103b provides an ordering and scheduling service to cause a UAV 125 to schedule a flight to inspect a location of an object. The request may include requirements of the UAV 125 such as the resolution and characteristic of the imaging device contained within the UAV 125, the range and ability to plan a flight to a location over a particular flight path, and the available schedule for a flight that meets any time or weather requirements of the user requesting the inspection to be performed. The delivery server 103a may coordinate the creation of a flight path with the air traffic controller server 103a. All of the data associated with the request for a flight, its scheduling, its status, and results may be maintained within a data exchange as otherwise disclosed herein for use by the repair report generator 154 and any other used of the data exchange.

Examples of systems that may be implemented using a set of processing nodes 110-113 including autonomous flying devices that utilize computing nodes are described in more detail in U.S. patent application Ser. No. 16/866,484, titled “Smart Drone Rooftop and Ground Airport System,” and filed on May 4, 2020, that itself claims priority to U.S. Provisional Patent Application No. 62/842,757, filed May 3, 2019, titled “Universal Automated Artificial Intelligence Rooftop UAS/UAV Drone Port/Airport Station For General Purpose Services Of Robotic UAS/UAVS, And Its Supporting Hardware & Equipment Related To: Loading/Unloading Deliveries, Deployment/Arrival, Dispatching, Air Traffic Control, Charging, Storing/Garaging, De-Icing/Anti-Icing, Meteorological & Data Dissemination/Retrieval, Big Data Mining And MIMO Network Services” and the U.S. Provisional patent application Ser. No. 17/187,871, titled “Smart City Smart Drone Uas/Uav//Vtol Mailbox Landing Pad” filed on Feb. 28, 2021, that claims priority to U.S. Provisional Patent Application No. 62/983,486, titled “Smart City Smart Drone Uas/Uav//Vtol Mailbox Landing Pad, filed Feb. 28, 2020. All of these applications are incorporated herein as if recited herein in their entirety.

The present invention addresses the limitations of prior solutions to these problems while working with other components of a Smart Drone Rooftop and Ground Airport System and the Smart Mailbox Landing Pad IP system. Using its AI-Machine Learning in a Delivery Drone Network and the Universal Computing Nodes in a Distributed Computing Environment IP will allow for the communication of sensors that are strategically positioned on top of existing building rooftops and vacant ground surroundings that have been repurposed as drone and vertical takeoff and landing vehicle (VTOL) smart airport/vertiport infrastructure. Each time a smart drone airport/vertiport is added to a roof national air space and national ground space is safer, and each time integrated sensors are daisy chained on smart airport/vertiports data gaps are filled between existing airports. Operators of aircraft, drones, unmanned vehicles, vertical take-off-and-landing vehicles, and robots will be able to rely on decentralized weather data, once not available, and will be willing to pay for example by trade, barter and or use fiat, credit, ACH, wire transfer, crypto and or minted tokens for it, because it has been validated. Operation of this system is described in detail in the related US patent applications cited above.

One of ordinary skill in the art will recognize that the above applications of universal computing node technology within a distributed processing system in support of autonomous flying devices may also be used in autonomous marine and ground-based environments in similar ways. Additionally, the use of universal computing node technology within a distributed processing system may be used to solve other data processing problems that arise as data is collected from sensors located across a large geographic area while the data from all of these sensors may be combined to represent data across the large geographic area at varying resolutions.

For example, local weather data may be collected from environmental sensors located adjacent to the distributed processing nodes that may be useful for autonomous devices within the geographic area at a fine resolution to operate as weather condition changes. The same weather data may be combined at a coarser resolution for route planning of the autonomous devices across the geographic area in a weather daisy-chained architecture. Even larger resolution weather data may be used for applications at regional and national levels. Use of the distributed processing nodes to process the raw weather data in increasingly larger areas with larger resolution allows all of these data representations of the same weather data to be generated using processing and data combining algorithms in a number of computing nodes. This processing utilizes the combined processing capacity of all of the computing nodes to permit large amounts of data to be processed simultaneously that may generate near-real time results for all of these levels of usage. Of course, similar applications to the weather processing from many other industries are easily supported in similar manners.

Additionally, the provision of a data exchange used in an autonomous UAV delivery system is one example embodiment of a data exchange that may be implemented by the present invention. The sensor data of the universal computing node obtained at the edge of a distributed computing environment may be any generated data that may be processed and stored onto a blockchain ledger. The generated data may be validated as disclosed herein to become validated data that may be trusted to the extent that the operator of the particular computing node generating the data may be a trusted source of data. The validated data, regardless of content, may be searched and identified using the metadata as disclosed herein. The validated data also may be acquired with a set of access rights as disclosed herein. The present invention is not intended to be limited to any particular example embodiment described here and is defined by the limitations recited within the attached claims.

The data exchange server 102 has positioned itself to be a hardware and software (node) that is hardware and software agnostic. The open platform is a scalable, interoperable, and modular autonomous smart self-healing node centric blockchain mesh network infrastructure of blockchain verified data, which can be daisy chained for situational awareness and detect and avoid features between nodes such as autonomous drones, manned aircraft, and manned and unmanned ground vehicles, sensors, landing pads, vertiports, charging stations, drone ports, smart delivery doorbells, smart delivery doorbell ringers, and other infrastructure hardware. This creates a beyond visual line of site (BVLOS) commercially viable and sustainable solution for the UAV and other industries. The Vertiport-in-a-Box (ViB) solution allows the system to integrate custom use case partners that provide autonomous hardware for air, ground and marine vehicles and software data sensors using our node application.

More generically, the present invention provides the first True Data Exchange©. In order to provide for a decentralized location where data can be discoverable and queried, a Data Exchange (DEX), Autonomous Mobility Data Exchange (AMX) and its Sub-Exchange(s), will support an autonomous market maker data exchange for data suppliers and data acquisition users. A True Data Exchange eco, designed to provide for hardware and software integration, data blockchain validation, data aggregation, and data market maker capabilities. This exchange will be launched from a launch pad, and or other public exchange(s), where AMX will have multiple industry specific exchange(s) and URLs which will come out in stages. These exchanges are the combination of being AMX Pools, AMX Network Architecture, and AMX Sub-Exchanges.

The AMX Pools use token economics, also known as “Tokenomics”, for token pools for specific categories. AMX will use sub-exchange proposal pools, data supplier access pools, user access pools, and user supplier pools, seed pool, private sale 1 pool, private sale 2 pool, public launch sales pool, liquidity pool, different types of node pools, staking pools, financing pools, development pools, token rewards pools, crypto rewards pools, advertising pools, DAO pools, and other custom pools as need.

The AMX architecture must have the flexibility and dexterity of an open network platform, crypto and token exchange. The present invention models both provided this solution. Key elements to achieve this goal are for the architecture to be industry decentralized (DeFi), data agnostic, open platform, interoperable, modular, scalable, multi exchange data storage for the depository and repository of data, data-on-demand, static data, dynamic data, and data fusion.

The AMX also provides for industry specific sub-exchanges, cross-sub-exchanges, cross-crypto, cross-tokens, cross-rewards, cross-promotions, cross-rewards and cross-NFTs. These exchanges include a weather data exchange, a drone delivery data exchange, and industry specific sub-exchanges. These industry specific exchanges will allow for data to be discoverable on a specific exchange. The AMX architecture also will allow users to repurpose data on multiple industry exchanges.

A HGTP horizontal hypergraph requires projects to create liquidity and bandwidth pools to access the network and create liquidity of L_0 tokens. The present invention requires liquidity and bandwidth support for its smart drone rooftop and ground airport/Vertiport©, smart mailbox landing Pad™, smart drone delivery Container©, smart delivery Container©, smart charging station, smart delivery drone, smart parcel mailbox, smart droneport, smart drone changing and storage hanger, smart delivery doorbell, smart delivery doorbell Chime©, and delivery drone mobile application. Through a staking program, the present invention provides liquidity providers rewards with tokens as an APY. The Platform Community Token Rewards program will be used to support the liquidity pool, development pool and other pools as needed. As a data provider, node operator, node minor, and or node validator, onboards, for example, a traditional and non-traditional manual and autonomous smart drone, smart landing pad, smart mailbox landing Pads™, smart charging station, smart Container©, UGV, robot, eVTOL, UMV, sensors, mobile driver, and user apps as a hardware and or software node to the network, the needed throughput on the hypergraph network will be increased and supported. The present invention provides these node solutions through its smart node centric mesh network in collaboration with the Hypergraph network. The cross-connection of the nodes communicating also allows for artificial intelligence and machine learning (AIML).

FIG. 2a illustrates a set of processing components used within a parts acquisition installer of the inspection system according to the present invention. The parts acquisition installer 153 receives information identifying one or more parts to be obtained in response to an inspection performed by a UAV 125 to determine the availability, cost, and time needed to complete a repair based upon the received information and all other available data. The parts acquisition-installer 153 uses a set of parts acquisition software components that comprises a parts acquisition controller 201, a parts availability locator 202, a parts criticality analyzer 203, a parts compliance analyzer 204, a parts cost analyzer 205, a parts internal manufacturer 205, a parts install scheduler 207, and a parts fatigue predictor 208. These software components 201-208 operate together to perform the functions of the parts acquisition installer 153.

The parts acquisition controller 201 is communicatively coupled to a parts acquisition database 211 and coordinates the interaction of the remaining software components 202-208 within the parts acquisition-installer 153. The parts acquisition database 211 stores a part data record for each part that is expected to be inspected and possibly replaced as part of an inspection and repair effort. The parts acquisition database 211 utilizes the part data record to provide manufacturer and supplier information that includes cost and current availability and lead time to delivery, technical part design documentation, part IDs, equivalent parts from alternate manufacturers, and part 3D printing specifications to create each part, if possible, on-demand or at a predetermined date certain request and or order. The parts acquisition controller 201 receives requests to determine the availability, cost, and delivery lead time for one or more identified parts from the parts identifier 152. The parts acquisition controller 201 exchanges data with the parts acquisition software components in order to determine the relevant parts acquisition information.

The parts availability locator 202 is communicatively coupled to a parts characteristic database 212. The parts availability locator 202 searches for an available source to obtain a replacement part from the one or more parts to be obtained in response to an inspection performed by a UAV 125 to determine the availability, cost, and time needed to complete a repair based upon the received information and all other available data. The parts availability locator 202 checks the parts characteristic database 212 to identify possible manufacturers and suppliers and includes cost and current availability and lead time to delivery, part IDs, and equivalent parts from alternate manufacturers.

The parts criticality analyzer 203 is communicatively coupled to a parts characteristic database 212. The parts criticality analyzer 203 determines for one or more of the requested parts whether any critical issues in need of urgent and immediate attention as well as emergency report message requirements associated with the identified critical issues using a parts characteristic data record in the parts characteristic database 212. The parts characteristic data record comprises a part ID, a manufacturer and supplier, and one or more critical issue definitions associated with the requested part. When critical issues are identified for a part, all critical issue and response data is returned to the parts acquisition controller 201 for use in selecting a suitable part to obtain a replacement part from the one or more parts to be obtained in response to an inspection performed by a UAV 125. The parts acquisition controller 201 attempts to select a replacement part that meets all of the technical requirements to use the part for a part that does not have any critical issues identified by the part criticality analyzer 203. When the parts acquisition controller 201 selects a part that includes one or more of critical issues for that particular part needed to be selected, all critical issue and response data is returned to a user to permit the selection of a part with critical issues to be confirmed. The critical issue and response data may also be used in determining the scheduling of installation of a replacement part when the critical issue impacts the time required to make a repair.

The parts compliance analyzer 204 is communicatively coupled to a repair parts regulation database 214 and determines all repair reports that are needed in response to the inspection performed by a UAV 125 based upon the received information and all other available data. The parts compliance analyzer 204 retrieves data from a repair parts regulation database associated with reporting requirements for the type of repair event associated with this part replacement request following an inspection. These regulations identify reports to be submitted when particular parts are part of a part replacement request based upon the identity of the part and other factors in the inspection data such as the use and location of the part to be replaced, the nature and risk of injury or death to workers and members of the public, the nature of the part, the materials of the part, the location of the purchase and or 3D manufacturing of the part, and the equipment and material required from the manufacturer to complete the project within the allotted time requested. Government regulations specify when a particular report is needed. When the parts compliance analyzer 204 identifies a report that is needed because of the facts and circumstances of the inspection and repair event, the analyzer identifies the needed report and defines the contents of the report is based on the inspection and repair. Any report determined to be needed is sent to the repair report generator 153 for preparation and submission of the report to the relevant parties and agencies.

The parts cost analyzer 205 is communicatively coupled to a repair parts cost database 214 that provides the cost associated with every available source, turn-around time, and delivery time required. These cost determinations may include all costs to deliver the selected replacement part in a specified timeframe. These costs may include cost of the part itself, all delivery charges that may be incurred, any rush charges needed to obtain the replacement part by a specified date, and any costs associated with handling, storing, and installing each part to the extent they differ for different available parts, as well as any costs needed to be collected sales or specific State and Federal taxes required upon sale and or delivery. The parts cost analyzer 205 determines the availability, cost, and time needed to complete a repair based upon the received information and all other available data. These cost determinations are returned to the parts acquisition controller 201 for use by the parts availability locator 202 for use in selecting a replacement part to be ordered. The cost determinations along with the available delivery dates also may be provided to a user to permit confirmation of a replacement part selection by the user.

The parts internal manufacturer 206 is communicatively coupled to a 3D printer 216 capable of fabricating the replacement part. The parts internal manufacturer 206 identifies all 3D printers 216 close to the installation location for the replacement part. The parts internal manufacturer 206 may determine the availability to use the 3D printer 216 as it relates to a possible availability date. The parts internal manufacturer 206 also may determine the costs to use the 3D printed replacement parts as well as the expected life cycle for the replacement parts to permit a comparison of the time, cost, and life cycle expected from a manufactured replacement part with the same time, cost, and life cycle for replacement parts from other sources. Lifecycles can be determined by digital twins, metaverse, omniverse and or simulation models.

The parts install scheduler 207 is communicatively coupled to a repair installation schedule database 214 useful when attempting to schedule an installation date for the replacement part. The repair installation schedule database 214 contains scheduling availability data for potential installation crews needed to install the replacement part. The scheduling availability data may include available installation crews and the associated members, the skills and availability of each member of the available installation crew, and costs associated with use of the available installation crew. The parts install scheduler 207 attempts to find an installation date and time using a crew that is available to perform the installation and provide all of the necessary skills needed to perform the installation. The parts install scheduler 207 may also use the installation costs of the crew required to install the replacement part when comparing replacement parts for selection.

The parts fatigue predictor 208 corresponds to the digital twin parts fatigue maintenance estimator. The parts fatigue predictor 208 estimates the fatigue-based part life cycle for a replacement part to determine how long use of the part may occur before the replacement part needs to be replaced for fatigue due to use of the part in its installation environment. This estimate of expected life cycle time of the part may be used to consider a subsequent part replacement cost when selecting the replacement part to be used, especially when the expected life cycles of two potential replacement parts differs significantly. The life cycle of each replacement part may be used by the parts cost analyzer 205 when selecting the replacement part to be used.

In all of the above databases coupled to one or more of the components described herein, data records are utilized to provide data defining one or more replacement parts with its characteristics, designs, functionality, uses, and alternative replacement parts. These data records are likely to be provided by the manufacturer and/or the supplier of the replacement parts. These entities are likely motivated to ensure data that aids in the selection of their respective replacement parts for use in the pending repair. Because this data is provided by these entities, the entities themselves may claim ownership in these data records. By including these records into the self-healing blockchain-based data exchanges, these entities may assert corresponding bundles of digital data bundle of rights to seek compensation for the access and use of the data when someone purchases and/or uses the inspection system 100 of the present invention.

In the situation in which an entity is accessing parts record data from one of the self-healing blockchain-based data exchanges, access to the data records for installation into the inspection system 100 may be accomplished by purchasing access rights to the data records. The user connects to the data exchange server 102 to key word, part, description, tag query and or find, select, and agree to the digital data bundle of rights (NFR, NFBOR) terms and conditions to for example purchase the access rights for the data records. The smart self-healing data exchange device packages the purchased data records into an NFT, NFR, and or NFBOR, that may be transferred to user for inclusion within the appropriate database. As such, the entities providing the data associated with the replacement parts for use in the inspection system 100 receive compensation for sale of access rights for each data record purchase. The user may access these data rights according to access rights based upon data sensitivity clearance and data defined within the bundle of digital rights associated with all data in the smart self-healing data exchange device. Crypto, Tokens, and Cross-Platform Tokens can be used for the tokenomics, in addition to fiat. This business model for using the smart self-healing data exchange device as a market sell and buy access rights to data stored within the smart self-healing data exchange device may be applied to any type of data that is stored within a smart self-healing data exchange device regardless of the type of data, the use of the data, and access rights granted within the smart self-healing data exchange device.

FIG. 2b illustrates a set of processing components used within a repair report generator of the inspection system according to the present invention. The repair report generator 154 prepares and submits a report of the results of a required inspection including a description of any repairs needed and completed in response to the inspection results to a governing regulatory agency or corporate entity. The repair report generator 154 uses a set of software components that comprises a repair report controller 221, a parts report data retriever 252, a report compliance requirement processor 253, a repair report generator 254, and a compliance report submitter 255. These software components 251-258 operate together to perform the functions of the repair report generator 154.

The repair report controller 251 coordinates the interaction of the remaining software components 252-255 within the repair report generator 154. The request to generate one or more reports is received by the repair report controller 251 from an external user. The repair report controller 251 obtains inspection data from the data exchange 121 via the repair report data retriever 252 to permit the report compliance requirement processor 253 to determine the number, type, and destination of repair reports needed by the associated inspection and repair activity. The repair report controller 251 may check to see if any of the required reports have already been generated and submitted to the relevant entities and if any of the inspection and repair data has been supplemented and/or modified since any prior reports have been generated. The repair report controller 251 sends the required reports to be generated and any special requirements to the repair report generator 254 causing the generation and submission of the reports.

The parts report data retriever 252 retrieves data from the data exchange 121 that contains all of the inspection and parts identification data used and generated within the repair report generator 154. The parts report data retriever 252 receives a request for one or more blockchain data records 500 from the data exchange 122 and retrieves a copy of the blockchain data records 500 for use within a generated report. The parts report data retriever 252 is responsible for communicating with the data exchange 121 and receiving the data and reformatting the data as necessary to provide it to a requesting software component 253-255.

The report compliance requirement processor 253 is communicatively coupled to a parts compliance report database 263 to determine and provide all of the requirements associated with a repair report to be generated from the data associated with the repair and inspection data stored in the data exchange 121. The report compliance requirement processor 253 receives the identity of all reports needed for submission in response to a particular inspection result and any repairs performed from the parts compliance report database 263. For example, an inspection and repair of a bridge used by the public for vehicles up to several tons in weight may require one particular report for an inspection not requiring a repair to a single road or transportation agency, a second report for an inspection requiring a repair of a non-critical part to one state and federal road or transportation agencies, and a third report for an inspection requiring a repair of a critical part to several state and federal road or transportation agencies as well as to state and federal public safety agencies. The report compliance requirement processor 253 determines the type of inspection and repair that forms the basis of the requested report to query the parts compliance report database 263 to identify all required reports and any special requirements to be followed in generating the required reports. The special handling requirements, for example, may refer to security of the data and confidentially of the reports for situations when the generated report is not intended for general or public release at the time the report is generated. Ongoing investigations of safety-related events that are inspected may provide one situation in which the generated report is kept confidential until the investigation is complete. All of these reports and associated requirements are provided to the repair report generator 254 via the repair report controller 251.

The repair report generator 254 is communicatively coupled to a repair reports database 262, receives repair report data obtained from the data exchange 121 via the parts report data retriever 252, and creates a repair report using a specified report format defined within an agency data record stored in the repair reports database 262 that's associated with the agency server 103j that is to receive the repair report. The repair report generator 254 sends requests for data specified in the agency data record stored in the repair reports database 262 from the data exchange 121 and inserts the data received in response to this request into a report document. Once all of the data specified in the agency data record stored in the repair reports database 262 has been inserted into the report document, the repair report generator 254 sends the completed and formatted repair report to the compliance report submitter 255.

The compliance report submitter 255 receives a completed and formatted repair report from the repair report generator 254 with an identity of an agency server 103j to which the completed and formatted repair report is to be submitted. The compliance report submitter 255 is responsible for communicating with the agency server 103j, providing access credentials to log into the agency server 103j as required, and for uploading the completed and formatted repair report to the agency server 103j.

The embodiments described herein with respect to all of the components of the parts identifier 152, the parts acquisition-installer 153, the repair report generator 154, and the digital twin parts predictive fatigue and lifecycle estimator 155 may be implemented as logical operations performed by a computer. The logical operations of these various embodiments of the present invention are implemented (1) as a sequence of computer implemented steps or program modules running on a computing system and/or (2) as interconnected machine modules or hardware logic within the computing system. Accordingly, the logical operations making up the embodiments of the invention described herein can be variously referred to as operations, steps, or modules. As such, persons of ordinary skill in the art may utilize any number of suitable electronic devices and similar structures capable of executing a sequence of logical operations according to the described embodiments. For example, the inspection system 100 may be virtualized for access by multiple users and/or applications either locally and or remotely. This characterization of the processing components also applied to the processing components within the data exchange and the universal computing nodes within the smart self-healing node centric blockchain mesh network as disclosed in the related US patent applications referenced above.

Additionally, the logical operations making up the embodiments of the present technology described herein can be variously referred to as operations, steps, or modules. In order to provide functionality according to some other embodiments, such steps, processes or methods may be performed in different orders than those described and illustrated in the drawings and one or more steps, processes or methods may be omitted. These modules may be implemented as software executing on a general purpose computing device, firmware executing with an embedded processing device within a component of a computing system, and a state machine based electronic sequencer that generates a sequence of electrical signals with an electronic device or devices that cause the sequence of operations described herein being equivalent. The implementation is a matter of choice dependent on the performance requirements of the computing system implementing the invention.

If implemented in firmware and/or software, the functions described above may be stored as one or more instructions or code on a computer-readable medium. Examples include non-transitory computer-readable media encoded with a data structure and computer-readable media encoded with a computer program. Computer-readable media includes physical computer storage media. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to store desired program code in the form of instructions or data structures and that can be accessed by a computer. Disk and disc include compact discs (CD), laser discs, optical discs, digital versatile discs (DVD), SD Cards, floppy disks and Blu-ray discs, and or USBs. Generally, disks reproduce data magnetically, and discs reproduce data optically. Combinations of the above should also be included within the scope of computer-readable media.

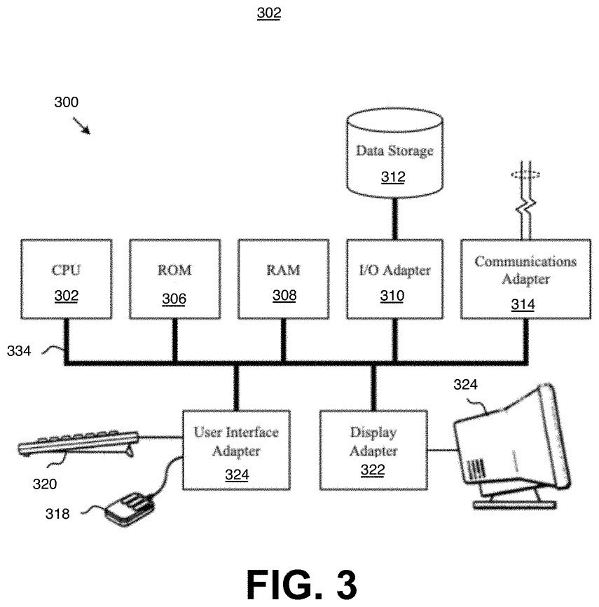

FIG. 3 illustrates a functional diagram of a generic computing system that may be used as part of an article of manufacture providing a universal computing node for use in a distributed computing environment used to support autonomous devices having blockchain processing, AI-machine learning processing, and a long-lasting power supply according to the present invention. FIG. 3 illustrates a computer system 300 adapted according to certain embodiments of the server and/or the user interface device for use as a distributed computing node according to the present invention. The central processing unit (“CPU”) 802 is coupled to the system bus 334. The CPU 302 may be a general purpose CPU or microprocessor, graphics processing unit (“GPU”), Bespoke Silicon Chip, and/or microcontroller. The present embodiments are not restricted by the architecture of the CPU 302 so long as the CPU 302, whether directly or indirectly, supports the operations as described herein. The CPU 302 may execute the various logical instructions according to the present embodiments.

The computer system 300 also may include random access memory (RAM) 308, which may be synchronous RAM (SRAM), dynamic RAM (DRAM), synchronous dynamic RAM (SDRAM), or the like. The computer system 300 may utilize RAM 308 to store the various data structures used by a software application. The computer system 300 may also include read only memory (ROM) 306 which may be PROM, EPROM, EEPROM, optical storage, or the like. The ROM may store configuration information for booting the computer system 300. The RAM 308 and the ROM 306 hold user and system data, and both the RAM 308 and the ROM 306 may be randomly accessed.

The computer system 300 also may include an input/output (I/O) adapter 310, a communications adapter 314, a user interface adapter 316, and a display adapter 322. The I/O adapter 310 and/or the user interface adapter 316 may, in certain embodiments, enable a user to interact with the computer system 300. In a further embodiment, the display adapter 322 may display a graphical user interface (GUI) associated with a software or web-based application on a display device 324, such as a monitor, display, or touch screen device of any kind.

The I/O adapter 310 may couple one or more storage devices 312, such as one or more of a hard drive, a solid state storage device, a flash drive, a compact disc (CD) drive, a floppy disk drive, and a tape drive, to the computer system 300. According to one embodiment, the data storage 312 may be a separate server coupled to the computer system 300 through a network connection to the I/O adapter 310. The communications adapter 314 may be adapted to couple the computer system 300 to the network 110, which may be one or more of a LAN, WAN, and/or the Internet. The communications adapter 314 also may be adapted to couple the computer system 300 to other networks such as a global positioning system (GPS), C-CAST, RaDAR, LiDAR, LoRaWAN, MIMO, WiFi, ADS-B, and or a Bluetooth network, to name a few. The user interface adapter 316 couples user input devices, such as a keyboard 320, a pointing device 318, and/or a touch screen (not shown) to the computer system 300. The keyboard 320 may be an on-screen keyboard displayed on a touch panel. Additional devices (not shown) such as a camera, microphone, video camera, accelerometer, compass, and or gyroscope may be coupled to the user interface adapter 316. The display adapter 322 may be driven by the CPU 302 to control the display on the display device 324. Any of the devices 302-322 may be physical and/or logical.

The applications of the present disclosure are not limited to the architecture of the computer system 300. Rather the computer system 300 is provided as an example of one type of computing device that may be adapted to perform the functions of a universal distributed computing nodes 101a-d. For example, any suitable processor-based device may be utilized including, without limitation, personal data assistants (PDAs), tablet computers, smartphones, computer game consoles, and multi-processor servers. Moreover, the systems of the present disclosure may be implemented on application specific integrated circuits (ASIC), very large scale integrated (VLSI) circuits, state machine digital logic-based circuitry, or other circuitry.

The embodiments described herein are implemented as logical operations performed by a computer. The logical operations of these various embodiments of the present invention are implemented (1) as a sequence of computer implemented steps or program modules running on a computing system and/or (2) as interconnected machine modules or hardware logic within the computing system. The implementation is a matter of choice dependent on the performance requirements of the computing system implementing the invention. Accordingly, the logical operations making up the embodiments of the invention described herein can be variously referred to as operations, steps, or modules. As such, persons of ordinary skill in the art may utilize any number of suitable electronic devices and similar structures capable of executing a sequence of logical operations according to the described embodiments. For example, the computer system 300 may be virtualized for access by multiple users and/or applications.

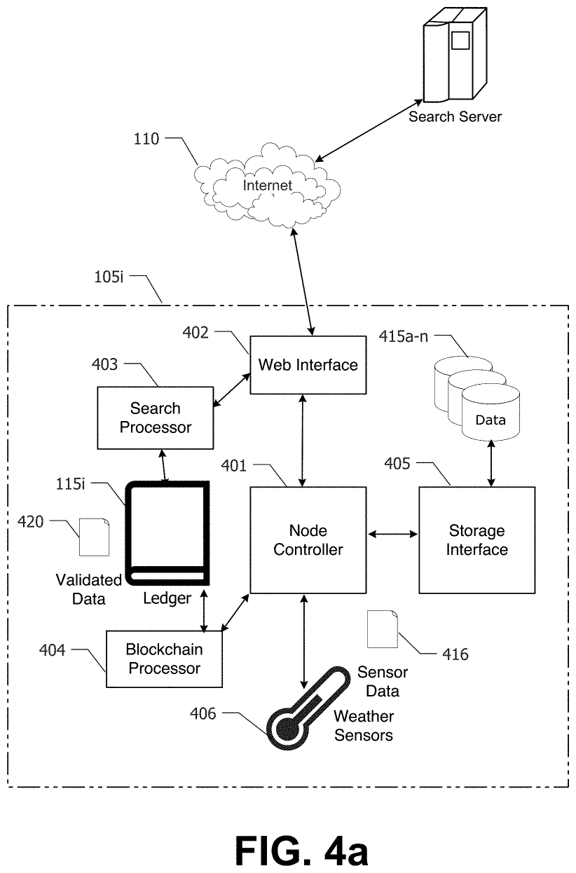

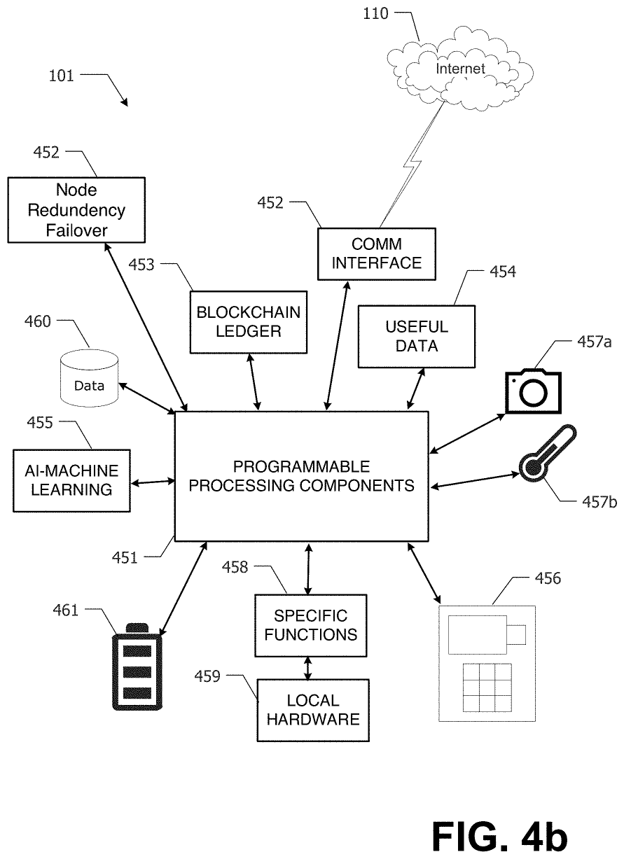

FIG. 4a illustrates a data exchange validated data record that may be used as part of a system for providing a drone based inspection system within a smart self-healing node centric blockchain mesh network having blockchain processing according to the present invention. The inspection system 100 of the present invention is an open platform that is hardware agnostic and software interoperable for all participating stakeholder manufacturers. The validated data can be blockchain validated through a Blockchain Validation as a Service (BVDaaS) solution. Once this data is trusted with integrity and scored for its reliability, it can now be repurposed for sale, lease, license, use and/or reuse through a discoverable dashboard query on a specific data exchange(s). The present invention provides this solution to make the existing models of autonomous infrastructure commercially viable and sustainable through the subsidization and monetization of the participating stakeholders near real time and or historic repurposed data supplied.

Aside from BVDaaS, additional vertical markets in this commercial building sector can be further broken down to accommodate an understanding of the building activity by the tenants and how it can relate to drone delivery revenue. One example of how the process works can be demonstrated in the bullet points below:
Onboarded Strategic Hardware Manufacturer Partners are integrated with a node on the smart node centric mesh operating system for direct edge computing.
Sensor Data Suppliers supply data using sensors through direct node, point-to-point and/or point-to-cloud and/or cloud-to-on prem services. This data can be used with their own operations related to a fleet of drones, drone customers and or sensors.
Consumer retail or food end-user orders come in from the smart node centric mesh operating system's Smart Delivery Drone Mobile App on a mobile phone.
The order is processed using the end-user's mobile device or online.
Blockchain origination begins on the end-user side of the participating app user.
Blockchain origination begins as participating drones, landing pads, charging stations, drone ports, drone hangers, drone containers, end points/edge that are being used in the storage, charging, departing, enroute and or arriving operations, which use sensor payloads on the edge (point) of the network, to begin the sensor data blockchain validation process of planning, approving, and executing the operational delivery objective.
On the point-to-point side of the hardware, artificial intelligence and machine learning (AIML) allow for all participating nodes (hardware) to edge compute and communicate with each other to share and learn information that is mission critical. This information can be weather conditions, object detection, and or hardware health, to name a few. Data that needs to go through the cloud will go directly to the data exchange. This information allows for beyond visual line of site (BVLOS), through situational awareness, autonomous decision-making, detecting and avoiding objects and adverse weather avoidance, minimize grounding of operations, and turn-key operational fulfillment.
Alternatively, an end-user can use Smart Mailbox Landing Pad™ and order on its digital touch screen interface between any of the competing shipping carrier delivery services such as USPS, FedEx, UPS, and or DHL.
During this process, participating strategic partners and stakeholders can opt in to having the data bifurcated into near real time streaming or placed in the repository to be sold on one of the data exchanges.
Data End-users can now go to the specific data exchange of interest and purchase, lease, license, use and/or reuse the data for their own specific use or purpose.
Users, node validators/operators and or data suppliers can receive token and or crypto rewards for program participation incentives when offered and may use the same for redemption and or purchase where applicable.

The inspection system 100 is developing the first of its kind autonomous delivery mobile and node-centric open platform network system. The inspection system 100 has combined its smart node centric blockchain mesh network IP application with its Smart Drone Rooftop and Ground Airport/Vertiport IP, Smart Mailbox Landing Pad IP, and its Smart Delivery Drone© Mobile Application as a one source solution for drone, vehicle and robot on-demand hailing via inhouse and participating third-party fleet supply chains through the system's interoperable, scalable and modular, delivery open platform that allows for data to be blockchain validated as trusted data with integrity and used for situational awareness and collision detection and avoidance, in order to provide an autonomous BVLOS delivery hailing service, using AIML for its near real-time decision making in its specific operational use. After operational use of data, it can be reclassified as trustworthy “repurposed data.”

Existing delivery transportation supply chain infrastructures bog down when introduced with more manually driven vehicles and trucks to sustain and maintain scalability. Roads and highways slow this delivery process down through traffic bottlenecking, stop signs, accidents, detours, weather, and labor power that is available. Multimodal milestone integration is key to the evolution of autonomy when it comes to transportation delivery. The smart node centric mesh operating system will use a software that permits the hailing of manual and autonomous vehicles currently existing in transportation, while transitioning the drones, eVTOL/VTOLS, UGVs, UMVs, and robots, throughout the regulation approval processes.

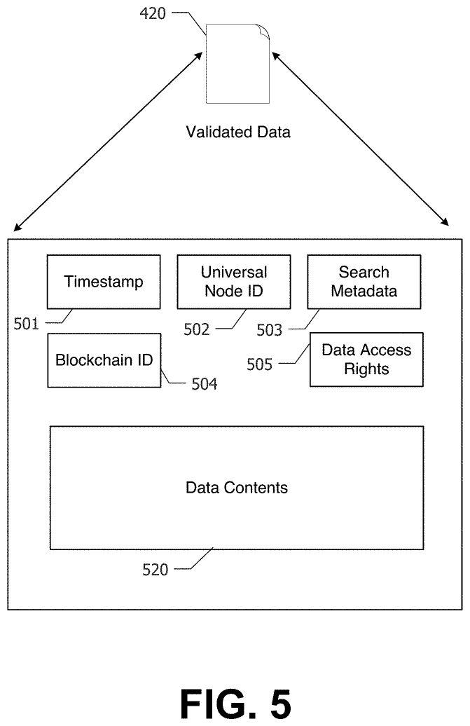

The inspection system 100 uses the data exchange server 102 as a search query processor that allows users to search for validated data 420 that is located within blockchain ledgers 115i of all of the universal computing nodes 105i shown in FIG. 4. The validated data 420 is created by the sensors 406 that is processed by the blockchain processor 404 for inclusion within the blockchain ledger 115i. The sensor data 416 is considered validated if it is obtained by a universal node that has been onboarded into the inspection system 100 as disclosed herein and a consensus among participating nodes are confirmed. The sensor data 416 is considered trusted as it is from a known source, these sensors 406, and is immediately processed within the blockchain processor 404 for inclusion in the blockchain ledger 115i. When a blockchain record of sensor data 500, as defined in reference to FIG. 5 below, is successfully added to the blockchain ledger 115i after it has been processed and agreed upon by a defined number of blockchain processors in separate universal computing nodes 105a-b, the data record is considered to be validated data 420. When a search for this data record is performed, the validated data 420 is known to be from its trusted source obtained on a date and at a time specified within the record 500 when retrieved from the blockchain ledger 115i. The data exchange search server 102 retrieves the record 500 and its validated data 420 from the ledger 115i upon request of a user submitting a search query. Operation of the data exchange search server 102 is described in detail below in reference to FIG. 7.

FIG. 4b illustrates a universal computing node for use in a distributed computing environment used within a data exchange for autonomous devices having blockchain processing according to the present invention. A universal computing node 105a may operate to perform any function that may be implemented in software containing executable instructions within an application. The computing node 105a may receive an application from a remote source such as an application server 103d that may work with local hardware 459 and local input devices such as imaging devices 457a and weather sensors 457b. The utilization of the application server 103d permits the development and usage of additional devices attached to the computing node 101 as needed to perform desired functions. The local hardware 459 and local input devices 456 permit inclusion of additional components that permit the computing node 105a to be universal in its possible functions.

The computing node 105a as disclosed herein is within a larger system that supports the use of UAVs 125 to perform autonomous deliveries of packages from vendors to purchasers using the smart mailbox landing Pads™ to accept deliveries and provide pickup locations of these packages as disclosed within the above cited and pending US patent application. The smart mailbox landing pads perform all of the functions to communicate with a UAVs 125 as it approaches the smart mailbox landing pad to make a delivery including identification and authorization to land and deliver packages as well as provide secure retention of the delivered packages until retrieved by a user. Any particular smart mailbox landing pad is typically in use a small portion of the time and for most instances the computing node 105a within the smart mailbox landing pad is available for other purposes.

The computing node 105a supports these other purposes by permitting the attachment of the local hardware 459 and the local input devices 457a-b to provide data to be generated for use by the UAV 205 and related air traffic server 103a functions needed by the UAVs 125. For example, the local input devices 457a-b may include any number of weather sensors 457b including temperature, wind speed, air pressure, humidity, precipitation, and the like. The local input devices 457a-b also may include an imaging device 457a that can provide real time images of present weather, road conditions, and traffic levels around the smart mailbox landing pad. Because the smart mailbox landing pads are typically located throughout a geographic area in which users are located, the inclusion of the local input devices 457a and weather sensors 457b is capable of providing critical near real time data useful for the UAVs 125 and the air traffic servers 103a when planning and monitoring the flight paths of the UAVs 125 as they occur.

All of the data generated by the computing node 105a may be transmitted to other computing nodes and servers for use as appropriate. The generated data also may be included within a secure data exchange for possible sale and use by any other computing systems. Additionally, the computing node 105a also may provide general computing capacity including computing operations and data storage that may be sold to other users in need of these services. As such, the capacity of the computing node is available when a UAV 125 is not engaged and is repurposed for these other usages.

Additionally, the functions performed by the computing node 105a may change over time as needed. The computing node 105a may download multiple applications from the application server 103a and time share the computing capacity of the computing node 105a to support different computing usages. The computing node 105a also may be within the UAVs 125 in which the local hardware 459 and the local input devices 457a-b correspond to the flight data inputs and flight controls of the UAVs 125 needed to proceed along a flight path. Of course, the computing nodes 105a also may be used in other devices and locations other than smart mailbox landing pads.

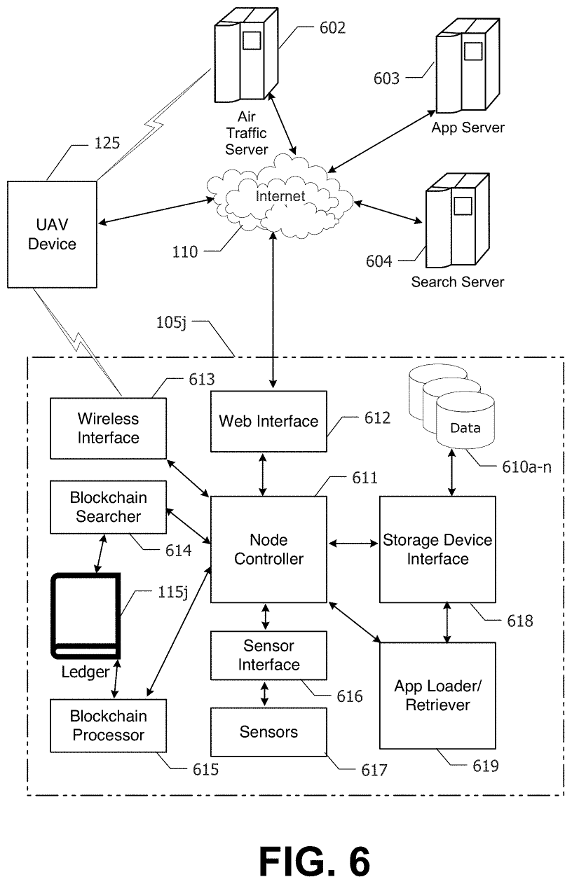

Additionally, the functions of the computing node 105a may utilize artificial intelligence and machine learning (AIML) using the sensor data 457a-b of the computing node 105a to determine operation of the computing node 105a when similar conditions arise within the sensor data 457a-b. The applications downloaded by the computing node may include and/or utilize these AIML functions throughout the operation of the computing node and its software components of FIGS. 6-7.

A computing node 105a of FIG. 1b may be constructed using one or more components including a set of programmable processing components 451, a communications interface 452, a blockchain ledger 453, useful data 454, a power source 461, an input control device 456, one or more external sensors 207a-b, a set of specific processing functions 208, local hardware components 209, local data storage 460, and AI-machine learning functions 4551.

The set of programmable processing components 451 includes all of the programmable hardware and memory used to create a computing device that may operate as a computing node 105a. A computing system is described in more detail with regards to FIG. 1b.

The communications interface 452 permits the programmable processing components 451 to communicate with remote user computing devices 102a-b and 101a-d. The communications interface 452 performs all of the data formatting, computer-to-computer communications, encryption processing, and all similar operations needed by the programmable processing components 451 to communicate with other nodes 101a-d and servers 102a-b.

The blockchain ledger 453 is a data storage system that is used to capture, mine, validate, log or ledger, and maintain data onto a distributed blockchain-based ledger for retrieval by the computing nodes 101a-d and other computing systems. The blockchain ledger 453 contains blocks of encrypted data and uses blockchain processing to ensure that the data retrieved from the ledger 453 is accurate and not corrupted. Blockchain processing stores data in multiple blockchain ledgers using directed acyclic graph and Hypergraph Transfer Protocol (HGTP) on different computing systems using all entries in the ledger in the computation of data stored into each block of data stored on the ledger such that any changes to a data entry in one of the data blocks added to the blockchain ledger 453 would cause all subsequently added data blocks to identify an error when retrieved and decrypted. The validation of the blockchain data is horizontal and scalable. The more data validation nodes, the faster it is. A simplified description of blockchain processing may be found at https://www.linkedin.com/pulse/how-does-blockchain-work-dummies-explained-simply-collin-thompson/ which is incorporated herein in its entirety.

Because blockchain ledgers 453 require identical ledgers be maintained in multiple computing systems, inclusion of a blockchain ledger 453 in each of the computing nodes 101a-d provides distributed processing systems that run in parallel and or horizontal to maintain the multiple copies of a particular ledger. A data block retrieved from the blockchain ledger 453 that matches a copy of the same data blocks from other computing nodes may be trusted to be an accurate copy of the data block when stored onto the blockchain ledger 453.

Blockchain ledgers 453 may be used to store any type of data that is generated or processed by computing systems. In the systems noted above that relate to autonomous devices, a blockchain ledger 453 may be useful to record data of the various flights of the autonomous flying devices, including date and time of each flight segment from a point of takeoff, a point of a destination, locations of any waypoints followed in a flight, weather data associated with the particular flight, and any information regarding the purpose of the flight, the cargo transported in the particular flight, and any point of sale information related to the cargo. As noted in the autonomous flying device descriptions, the computing nodes may be associated with rooftop airports, smart mailbox landing pads, and related devices that are spatially distributed across a geographical area that have functions associated with the distributed devices that have computer control functions. The blockchain ledgers 453 and associated processing may proceed as background processing functions when the computing nodes 101a-d are not needed by the autonomous flying device control system. Data and services that is generated within the State Channels that are within the Layer Zero (L_0) and Layer 1 (L1) network of the hypergraph (HGTP) do not incur gas fees but may incur micro and other micro fees for transactions within the state channels.

Useful data 454 may be generated by each computing node 101a-w based upon the functions and devices that are part of a particular computing node. For example, a computing node 101 may collect local data from attached sensors 457a-b to computing nodes 105a that are spatially distributed across a geographical area. Real-time weather data is one type of data that may be captured at a large number of computing nodes 105a across the geographical area. All of this weather data from all of the computing nodes 101a-d may be combined together into a real-time view of weather conditions across the geographical area. This weather data may be combined into a common weather map using a set of processing nodes 101a-d and additional servers on the smart self-healing node centric blockchain mesh network. This weather map may be useful to an autonomous flying device control network; additionally, this weather map data may be useful to other users on the Internet 110. As such, the weather maps may represent one type of useful data that is generated and maintained in a computing node 101 that may be provided to other systems to increase revenue generated by the set of processing nodes 101a-d

The power source 461 may be used to provide electrical energy to operate the computing node 105a, any attached sensors 457a-n, local hardware components 459, and network communication functions associated with each computing node 105a. Certain computing nodes 105a and related attached devices may be located when a power connection to a power grid is difficult and expensive to be provided. Additionally, other computing nodes 105a, such as computing nodes 105a that are part of autonomous flying devices, may be mobile devices that require a self-contained power source. The power source of the present invention 461 may comprise a Tritium™-based power source that provides a power source having a long useful life providing electrical power. Examples of these power sources many include many types of self-charging, nano-diamond, and diamond nuclear voltaic batteries. Other long-life power sources include solar power devices, hydrogen power generating devices, and similar nuclear-based power sources 416 having a useful long life.

The input control device 456 provides input and output processing to provide operators of the computing nodes with messages and data needed to control the operation of the computing node 105a and its functions. This input control device 456 also accepts commands from a user to instruct the application in the computing node 105a to perform particular tasks.

The one or more external sensors 457a-b may be connected to each computing node 105a to provide data that may be useful for the functions performed by a particular node. As noted above, a computing node 105a may collect local data from attached sensors 457a-b to computing nodes 105a that are spatially distributed across a geographical area. This local data may include images, video, and audio data from a camera device 457a that provide a real-time view of an area about the computing node 105a. This local data also may include weather data from sensors 457b that measure data including temperature, wind speed and direction, humidity, barometric pressure, and precipitation, among other data values. The computing node 105a may collect the data values from these sensors 457a-b to provide to other computing devices on the Internet 110 as well as use the data values to generate other data that may be useful to other processing nodes 101a-d and other computing devices.

The set of specific processing functions 458 may be part of a computing node 105a to control local hardware components 459 that are part of the location of the computing node 105a. For example, a computing node 105a may be part of a rooftop airport or a smart mailbox landing pad that are used to launch and receive autonomous flying devices. The airports and smart mailboxes may require processing functions to communicate with the autonomous flying devices as part of the control of these flying devices. Additionally, a smart mailbox may include components that open and close to provide storage for mail and packages to be received when an autonomous flying device arrives at the smart mailbox. The set of specific processing functions 208 may control the operation of the smart mailbox as well as notify a user of the arrival of a package as appropriate. The set of specific processing functions 458 provides all processing functions to support the devices that are associated with the computing node 105a at a particular location.

The local hardware components 459 are the physical components to permit the computing node to operate as a specific device. For example, a smart mailbox, as noted above, may have devices to communicate with the autonomous devices, to accept packages from the autonomous devices, and communicate with users about arrival of a package by the smart mailbox. These local hardware components 459 are used to allow the computing node 105a to function as any particular device or system.

The local data storage 460 contains semi-permanent and permanent data storage devices to store data used by software applications executed by the computing node 105a, store and provide data as needed to the software applications executed by the computing node 105a, and store various software applications that may be used to dynamically configure a computing node 105a from one set of processing functions to another set of processing functions. The local data storage may be contained within devices attached to the location of the computing node 105a as well as be contained within devices communicatively connected to the computing node 105a over the Internet 101.

The AI-machine learning functions 455 may be included within a computing node 101 to assist in functions to be performed by the computing node 105a and its attached devices. As the state of AI-machine learning functions continue to mature, the inclusion of these functions may be useful in a large number of areas. For example, computing nodes 105a that are part of an autonomous device network may include a number of functions associated with the control of the autonomous devices, the routing of the autonomous device travel paths, the detection of dangerous conditions associated with local weather conditions and possible in route collisions, situational awareness for detection and avoidance of possible collisions between the autonomous devices, and dynamic rerouting of autonomous devices as needed. All of these processing functions may benefit from the use of AI-machine learning functions 455 to provide improved functioning of the computing node 105a based upon data obtained from the particular location of the computing node 105a.

Edge universal computing nodes can communicate peer-to-peer, point-to-point, point-to-cloud, point-to-cloud-to-on prem. and is agnostic with other nodes who wish to transfer data on to the network. Near real time daisy chaining of data between nodes can create an AIML environment between nodes communicating on the smart node centric blockchain mesh network.

For the example embodiments disclosed herein, the universal computing nodes are disclosed as computing devices used in a system of UAVs working in combination with Smart Mailbox Landing Pads and Rooftop UAV Airports and Landing Pads as disclosed above. These universal computing nodes also may collect and share local weather data at the corresponding universal computing node for use by the UAVs and related systems as well as provide data to be included within a Weather Data Exchange (WDX) as described in detail herein. One of ordinary skill in the art will recognize that the universal computing nodes also may be used in many other distributed computing systems and low latency blockchain data exchanges. The embodiments of the UAV systems and weather data exchange are described as representative example embodiments of the present invention. These embodiments are not intended to limit the scope of the present invention except as recited in the limitations of the attached claims.

FIG. 5 illustrates a set of universal node software components that may be used as part of a system for providing a drone based inspection system within a smart self-healing node centric blockchain mesh network having blockchain processing according to the present invention. Validated data 420 is stored within the blockchain record 500 that comprises at least the following data fields: a timestamp field 501, a universal node ID field 502, a sensor metadata field 503, a blockchain address ID 504, a data access rights field 505, and a data contents field 520.

The timestamp field 501 contains time and date data corresponding to the date and time when data from the sensors 406 was captured. Using the example embodiment of a universal computing node 101i that collects weather data, the timestamp field 501 captures when the weather data was recorded. The timestamp data may be used to determine whether the weather data contained within the blockchain record 500 is too stale to be considered current weather condition measurements for use with UAVs currently airborne about this particular universal computing node 101i. This timestamp data also may be used when past conditions at a specified time is needed and is retrieved from the blockchain ledger 115i. Sensors such as LiDAR data can use this weather data to be used for digital twin, metaverse and omniverse, as well as VR, AR, and MR.

The universal node ID field 502 contains a unique identifier that corresponds to the universal computing node 101i that generated the data contained within the blockchain record 500. This unique identifier will identify the source operating the universal computing node 101i as well as its location.

The sensor metadata field 503 defines the contents of the blockchain record 500 in terms to be used when a search is performed for requested data. The universal computing node 101i is configured to specify relevant terms that will permit the record to be found when needed. For the embodiment that collects weather data, the month, day, and year of the data's collection, the location of the sensors when the data was collected, and the types of data contained therein typically is used for the contents of the sensor metadata field 503. This metadata may be configured when the universal computing node 101i is initialized. The metadata also may be updated periodically when other useful terms may be associated with the sensor data when it is being collected and may also be fused with other data used in UI and UX platforms. For example, weather data collected as a named storm is passing by the universal computing node 101i may be a useful metadata value which would allow users to search for all data associated with “Hurricane Amy” for data collected when this particular named hurricane was in the vicinity. This particular metadata term may then be removed from insertion into new blockchain records 500 once the hurricane has moved on.

The blockchain address ID 504 contains a unique address corresponding to the location of the blockchain record 500 within the blockchain ledger 115i. All blockchain ledgers identify their location within the ledger permitting specific data records be retrieved from any universal computing node maintaining a copy of this particular ledger.

The data access rights field 505 contains a default set of digital data rights that may be obtained for the data within a particular blockchain record 500. As disclosed in detail in reference to FIG. 7 below, data within the data exchange may be acquired by a user in one or more of a defined set of type of digital rights available for purchase. The owner of the collected data may specify how the data may be acquired and the possible types of rights are identified in the data access rights field 505. For example, data within a data record 500 may be acquired for use for a limited period of time or may be acquired with a specific set of permissible uses. These access rights are set by the data owner. The type of access rights may change over time as the nature of the data changes. For weather data, permissible uses of data that is considered current may be different from permissible uses once the weather data is considered historical. The price associated with each permissible use and type of access rights granted may depend upon the nature of the data at the time when the data is used as well as when it was acquired.

The data contents field 520 contains the data from the sensors 406. The particular sensors used, their serial numbers, and other relevant information associated with the data is contained in the data contents field. Of course, the contents of the data may vary depending upon the sensors, the associated data scales of the data, any language of users of the data, and many other values may be contained in this data field. Alternatively, additional fields also may be included within the blockchain data record 500. For example, an additional field that states whether temperature data is measured in Fahrenheit or Celsius data. Similarly windspeeds may be measured in miles per hour or meters per second depending upon the sensor and the data usage.

FIG. 6 illustrates a set of software components in a universal computing node used according to the present invention. FIG. 6 shows a set of software components 600 used within a universal computing node within a distributed computing device within a network of UAVs, rooftop UAV airports and landing pads, and remote UAV landing pads such as the Smart Rooftop Airport and Landing Pad and the Smart Mailbox Landing Pad disclosed in the commonly owned U.S. Patent Applications cited above.

The set of software components 600 comprises a node controller 611, a web interface 612, a wireless interface 613, a blockchain searcher 614, a blockchain processor 615, a storage interface 618, an app loader/retriever 619, and a sensor interface 616 coupled to a set of sensors 617.

The node controller 611 acts as a central controller for the set of software components 612-619. Commands from the applications are received and processed to determine actions to be taken, and then mobile app commands are passed to the other software components 612-619, as needed, to implement the actions to be taken. The node controller 611 also may receive and process data received from the web interface 612, the wireless interface 613, and the local hardware and local input devices for use in the applications running on the computing node 101i.

The web interface 612 permits the computing nodes 101i to communicate with remote computing devices such as application servers 113d, air traffic servers 103a, item delivery servers 103b, node redundancy servers 103c, and mobile UAVs 125. The web interface 612 performs all of the data formatting, computer-to-computer communications, encryption processing, and all similar operations needed by the computing node 101i to communicate with these remote systems and devices.

The wireless interface 613 also permits the computing nodes 101i to communicate with remote computing devices such as application servers 113d, air traffic servers 113a, item delivery servers 103b, node redundancy servers 103c, and mobile UAVs 125 over a wireless communications channel. The wireless interface 613 is especially useful to permit a computing node 101i to communicate with a computing node within a UAV 125 while in flight. The wireless interface 613 performs all of the data formatting, computer-to-computer communications, encryption processing, and all similar operations needed by the computing node 101i to communicate with these remote systems and devices.

The blockchain searcher 614 receives a search query from a user via the data change search server 101 as described below in reference to FIG. 7 The blockchain searcher 614 uses the search query to identify blockchain records 500 in which the terms within the search query match the metadata terms within the blockchain data record 500. In some embodiments, the blockchain searcher 614 may maintain a search index (not shown) containing pointers to the blockchain data records 500 having particular metadata values. This search index may be updated when a new block chain data record 500 is added to the blockchain ledger 115i. Other searching techniques and related database structure may be included in the blockchain searcher 614 to perform fast and efficient searches for matching blockchain data records 500.

The blockchain processor 614 performs blockchain operations to maintain data within the blockchain ledger 115i used to provide security and data integrity for the data changes as disclosed herein.

The storage interface 618 provides input and output processing to provide a node controller 611 and all other software components 612-619 with data needed to perform the functions implemented in the application running in the computing node 101i. This storage interface 618 maintains all data stored on the local storage devices 610a-n as well as stores, retrieves, and deletes the data stored within the local storage device 610a-n as needed.

The app loader/retriever 619 receives commands from the node controller 611 to locate and download one or more mobile applications from the application server 603 for use within the computing node 101i. The app loader/retriever 619 sends requests to the application server 603, downloads applications from the application server 603, stores the applications into the local storage devices 610a-n for later use, and retrieves the applications from the local storage devices 610a-n for execution within the computing node 101i when needed. The app loader/retriever 619 also may periodically check for updates to previously downloaded applications and download updates from the application user 603 to permit the computing node 101i to maintain a current version of the applications.

The sensor interface 616 provides input and output processing to receive input data from the local sensors 617 to provide a node controller 611 and all other software components 611-618 with data needed to perform the functions implemented in the application running in the computing node 101i.

FIG. 7 illustrates a set of data exchange data records search that may be used as part of a system for providing a drone based inspection system within a smart self-healing node centric blockchain mesh network having blockchain processing according to the present invention.

The data exchange data record search server may provide Decentralized Financing (DeFi) through cryptocurrencies and participating currencies, tokens, the launch pad and staking programs. One can participate by locking up (staking) a cryptocurrency for a period and receive rewards, incentives and/or staking of a cryptocurrency itself. Launchpads can be used for blockchain projects and funding can be launched through the same method. The data exchange data record search server incorporates all these features to reward stakers and users using social interactions of data suppliers, users and the data itself, allow for “node gamification” rewards opportunities for end users using the mobile applications, but will also allow the stakers to have their own incentives and opportunities for participation. Reward points, NFTs, and cross-currencies are maintained and stored in the digital wallet. This creates a utility between real world tangible real assets and digital assets.

Additionally, participating cities and municipalities can now invest in sensor data infrastructure that they themselves can subsidize and or monetize through the systems industry specific exchange(s). Once turned on, the data exchange data record search server can identify them as a node data supplier; the sensors are not limited to the repurposed roofs and ground areas over the private sector. Existing institutional buildings such as police stations, airports, hospitals, roads, highways, bridges, railways, bus stations, train stations and other transportation multimodal rooftop solutions can provide for sensors that are data driven and that can become discoverable for other government agencies' use through cross-platform demand. Any data that is not deemed confidential and or classified can be repurposed for sale, lease, license and/or free to the public and private sectors. Infrastructure inspections for powerlines, highways, bridges, and towers can now be more cost effective and less risky when carrying out the public services to maintain and monitor them. Police dispatch and first responder features will allow for time sensitive and lifesaving critical data that could have been lost without the quick access and execution of trusted data.

Discoverable data for end users such as drone operators, industry analysts, universities, aviators, meteorologists, scientists, public and private sector data acquisition companies, construction, real estate companies, municipalities, legal entities, law enforcement, military and even just someone who simply would like to know the daily weather on their smart phone, to name a few, have been trapped in centralized government, institution, and industry specific sectors that are either unknown or not discoverable to other market sectors as being trusted reliable integrity data that is available for purchase, lease, license, use, and/or reuse and or other custom terms and condition. Most used data is purged, dumped, deleted and/or stored for historic memorialization because it either has no specific use other than what it was intended for from its inception, it is too costly to store if it has no further purpose, there is no place they know where to market the data, the data has a specific shelf life, the information is confidential or classified and the owner doesn't know when it will be declassified or if they can repurpose the specific data they are able and willing to sell, and/or the data is not verifiable and therefore not a reliable as data with integrity that can be tracked to its source, giving little to no value to the end user who might want to purchase the data or to the data supplier who put the sweat into originating the data who deserves to be paid for their labor.

The data exchange data record search server may operate as Blockchain Validated Data as a Service (BVDasaS), Blockchain Validated Data Storage as a Service (BVDSasaS), and Data Market Maker as a Service (DMMaaS).

The BVDasaS permits users to mine, validate and monetize raw, modeled, and co-op modeled data. The data exchange data record search server introduces the concept of “repurposing of data” © on decentralized subject-specific discoverable data exchange(s) that will allow for data suppliers and data users to have a go-to data market where they can query and purchase and/or lease specific data on a discoverable data exchange, that they can rely on as validated. Chain of custody of the data via blockchain allows data suppliers and stakeholders to be compensated for the data they have put through the BVDaaS interoperable open platform data exchange model.

The BVDSasaS addresses the need to store validated data by depository and/or repository methods. BVDSasaS will provide data storage after the blockchain validation process for data to be discoverable as trusted data on one or many data exchanges.

DMMaaS creates a market as the market maker for data suppliers and data users via industry specific data exchange(s). Data suppliers will be able to place blockchain validated data on the data exchange or sub-exchanges. Here is where data users will be able to purchase, lease, license, use, reuse and/or receive for free this discoverable data. By simply providing a query request of a key word or words that the data supplier set up in its back-office dashboard account, the end-user can discover trusted data that has been validated through the network's node consensus system on the L-0 network layer.

The present invention may be used to create an autonomous delivery infrastructure system of systems by repurposing existing infrastructure and data through the steps of mining, cyber secure data validating and providing monetization solutions, so that it has positioned itself through its ViB solution to be the relied upon open platform system as the autonomous interoperable integrator of hardware and software, the aggregator of participating sensor data suppliers, with discoverable integrity data to the participating end users, as a market maker of trusted, monetized and rewarded data.

In order to perform all of the above functions, the data exchange search server 604 software components comprise a server controller 701, a server web interface 702, a search query processor 703, a payment processor 604, a web search engine 705, an operator interface 706 coupled to user input/output devices 711-712, a user account manager 707, a database engine 708, an access rights manager 709, and a node redundancy failover processor 721 coupled to a node failover substitute database 722.

The server controller 701 acts as a central controller for the set of software components 702-709. Operator commands from the operator input devices 711-712 via the operator interface 706 are received and processed to determine actions to be taken, and then server commands are passed to the other software components 702-709, as needed, to implement the actions to be taken. The node controller 701 also may receive and process data from the web interface 702, associated with search queries from user search computers 721a-b. The search queries are passed to the search query processor 703 for transmittal to a universal computing node 101i to perform a search against a blockchain ledger 115i.

The server web and web3 HGTP interface 702 permits the data exchange search server 604 to communicate with remote computing devices such as universal computing nodes 101a-n, application servers 603, air traffic servers 602, and mobile UAVs 125. The web interface 702 performs all of the data formatting, computer-to-computer communications, encryption processing, and all similar operations needed by the computing node 101i to communicate with these remote systems.

The search query processor 703 generates the search results for available blockchain data records 500 within the blockchain ledger 115i based upon a query or browse request from the users' computers 721a-b. The query or browse request includes search terms, blockchain ledger address IDs and universal computing node IDs, timestamp ranges, metadata terms to be matched, and possible location data associated with the universal computing nodes that are used by the search query processor 703. The generated search results are returned to the users' computers 721a-b via the server web interface 702

The payment processor 704 receives user payment information from the user account manager 707 in order to submit a request for payment from a remote bank account transaction server (not shown). The user payment information may comprise credit and debit card information needed to initiate a payment for access rights to blockchain data records 500. The user payment information also may be electronic check routing and account numbers needed to initiate a payment for access rights to blockchain data records 500. Payments can be made by digital wallets with crypto and token. The payment processor 604 receives a request for payment from the access rights processor 709 once a user has submitted a request to acquire access to digital data. Once payment has been received, the payment processor 604 returns a notification to the access rights processor 709 that it can release the access rights to the user. The payment processor 704 can accept as payment fungible and fon-Fungible tokens, rights, crypto, stablecoin, social and online payment methods, digital wallet payment methods, credit cards, rewards, data barter, and any similar currency or its equivalent with either zero gas fees and or micro and or custom transaction fees

The web search engine 705 provides users' computers 721a-b a search user interface to locate and retrieve search results and corresponding blockchain data records 500. The web search engine 705 presents search options to the users' computers in a graphical user interface (GUI) allowing users to log into the data exchange search server 604, to submit search queries that are processed by the search query processor 703, and to acquire access rights and download blockchain data records 500. The web search engine 705 uses the payment processor 704 and the rights access processor 709 to satisfy requests to acquire access rights and download blockchain data records 500.

The operator interface 706 coupled to user input/output devices 711-712 provides input and output processing to provide a server operator with messages and data needed to perform, configure, operate, maintain, and backup the data exchange search server 604. This interface module 706 also accepts commands from the user input/output devices 711-712 to instruct the server to perform these tasks.

The user account manager 707 permits users to connect to and access the data exchange search server 604. The user account manager 707 is responsible for creating and managing user accounts for the users 721a-b, and universal computing node administrators (not shown). The user account manager 707 also is used in authenticating a user based upon user input. Typically, the user input uses a username and password. Multi-factor authentication, use of one-time passwords, and similar secure authentication mechanisms may be included in the user profile. For every sign in the system will recognize the user type, i.e. the users 721a-b, and universal computing node administrators, along with all past activities from account details in the database. Based on user type, the data exchange search server 604 behavior will change.

The database engine 708 processes all database operations for the databases and local storage devices 710a-n. The database engine 708 searches for server data records (not shown) within the databases and local storage devices 710a-n. The server data records may comprise user account records, user data purchase payment records, access rights data records, and search query logs. These operations include insertion of server data records into the databases and local storage devices 710a-n, deletion of server data records from the databases and local storage devices 710a-n, searching and retrieving server data records from the databases and local storage devices 710a-n, and indexing the databases and local storage devices 710a-n to maintain efficient searching when needed.

The access rights manager 709 accepts user requests to obtain Digital Data Bundle of Rights for one or more blockchain data records as a backend oracle. As noted above, the user may acquire dynamic and or static data access rights, data type access rights, file access rights, data format access rights, video access rights including view and rebroadcasting rights, audio access rights including view and rebroadcasting rights, communication frequencies, spectrums, and any other monetizable set of rights and obligations. The access rights manager 709 determines the type of access rights that are available for each blockchain data record 500 in which access rights are to be granted. The access rights manager 709 determines the price for the particular access rights requested and provides the price to the user. If the user accepts a price and provides payment information, the access rights manager 709 sends a request for payment to the payment processor 704. Once the payment processor 704 indicates that payment has been received, the access rights manager 709 grants access to the particular blockchain data records 500. This access grant may also be documented in the data exchange search database and local data storage devices 710a-n in order to provide access to these data records at a later date. If the access rights manager 709 determines that a request data record has already been granted access rights, the access rights manager 709 may immediately grant a user access to the data.

The node redundancy failover processor 721 coupled to a node failover substitute database 722 within the redundancy server determines the sensors attached to the universal computing node 105a that has the failure as well as determines the functions performed by this universal computing node 105a within the smart self-healing node centric blockchain mesh network 131.

With this information, the node redundancy failover processor 721 identifies other universal computing nodes 105b within the smart self-healing node centric blockchain mesh network 131 that may replace the functionality of the failed computing node and coordinates the failover of the existing functions of the failed computing node to its replacement node. This failover may include transferring any data stored within the failed node to the replacement node The failover also may include transmitting a message to one or more universal computing nodes and servers within the smart self-healing node centric blockchain mesh network 131 that the failover is occurring. The other nodes within the smart self-healing node centric blockchain mesh network 131 may update their configuration data to address all data requests and related communications that had been assigned to the computing node that has failed to the replacement computing node. As such, the smart self-healing node centric blockchain mesh network 131 continues to operate after a brief failover as if the failure had not occurred.

All of the various embodiments of the inspection system 100 and any of its components have been described as how they may be used in an autonomous UAV-based inspections system. These embodiments are provided as exemplary embodiments of the present invention. The present invention is not intended to be limited by any of the particular embodiments and should be defined solely using the limitations recited within the attached claims.

Even though particular combinations of features are recited in the present application, these combinations are not intended to limit the disclosure of the invention. In fact, many of these features may be combined in ways not specifically recited in this application. In other words, any of the features mentioned in this application may be included in this new invention in any combination or combinations to allow the functionality required for the desired operations.

No element, act, or instruction used in the present application should be construed as critical or essential to the invention unless explicitly described as such. Further, the phrase “based on” is intended to mean “based, at least in part, on” unless explicitly stated otherwise.

What is claimed is:

1. An inspection system for providing an autonomous visual inspection system having an autonomous unmanned aerial vehicle (UAV) and an image capture device communicatively connected to a smart, blockchain-based data exchange storage and verification device and one or more universal computing nodes within a self-healing node centric blockchain mesh network, the inspection system comprises:
the autonomous unmanned airborne vehicle having the image capture device coupled together for generating image data used in inspections;
the blockchain-based data exchange storage and verification device for maintaining image data, identified parts data, parts acquisition data, parts report data, and repair reports and corresponding repair data;
a parts identifier, the parts identifier being an application programming interface to a remote third-party image analysis and component identification system, and the parts identifier generates one or more potential part identifications from the image data generated by the autonomous unmanned airborne vehicle;
a parts acquisition installer, the parts acquisition installer schedules installation of a replacement part selected from the one or more potential part identifications from the parts identifier;
a repair reports generator, the repair reports generator generates one or more repair reports based upon data stored within the blockchain-based data exchange storage and verification device; and
a digital twin parts predictive fatigue and lifecycle maintenance estimator, the digital twin parts fatigue maintenance estimator being an application programming interface to a remote third-party digital twin modeling and simulation based parts fatigue and maintenance estimator, and the digital twin parts fatigue maintenance estimator generates a fatigue-based part life cycle for the one or more potential part identifications from the parts identifier.

2. The inspection system according to claim 1, wherein the parts acquisition installer wherein comprises:
a parts acquisition controller, the parts acquisition controller coordinates the interaction of software components within the parts acquisition installer;
a parts availability locator, the parts availability locator identifies available sources with estimated cost and expect delivery dates for the one or more potential part identifications from the parts identifier;
a parts criticality analyzer, the parts criticality analyzer determines for one or more of the requested parts whether there are any critical issues in need of urgent and immediate attention as well as emergency report message requirements associated with the identified critical issues;
a parts compliance analyzer, the parts compliance analyzer determines all repair reports that are needed in response to the inspection performed by a UAV based upon the received information and all other available data;
a parts cost analyzer, the parts cost analyzer provides replacement part costs associated with every available source and delivery time required, the replacement part costs comprise all costs to deliver the selected replacement part in a specified timeframe, the replacement costs comprise a cost of the part itself, all delivery charges that may be incurred, any rush charges needed to obtain the replacement part by a specified date, and any costs associated with handling, storing, and installing each part to the extent they differ for different available parts;
a parts internal manufacturer, the parts installation manufacturer identifies all available 3D printers close to an installation location for the replacement part and determines costs to use a manufactured replacement part.
a parts install scheduler, the parts install scheduler finds an installation date and time using a crew that is available to perform the installation and may possess all of the necessary skills needed to perform the installation; and
a parts fatigue predictor, the parts fatigue predictor corresponds to the digital twin parts fatigue maintenance estimator.

3. The inspection system according to claim 2, wherein the parts acquisition controller is communicatively coupled to a parts acquisition database;
the parts acquisition database provides a part data record to record manufacturer and suppliers that includes cost and current availability and lead time to delivery, technical part design documentation, part IDs, equivalent parts from alternate manufacturers, and part 3D printing specifications to create each part; and
the parts acquisition database being stored within the blockchain-based data exchange storage and verification device.

4. The inspection system according to claim 2, wherein the parts availability locator is communicatively coupled to a parts characteristic database;
the parts characteristic database provides a part characteristic data record that comprises data to identify possible manufacturers and suppliers that includes cost and current availability and lead time to delivery, identifies part IDs, identifies equivalent parts from alternate manufacturers; and
the parts characteristic database being stored within the blockchain-based data exchange storage and verification device.

5. The inspection system according to claim 2, wherein the parts criticality analyzer is communicatively coupled to a parts regulation database;
the parts regulation database provides a part ID, a manufacturer and supplier, and one or more critical issue definitions associated with the requested part; and
the parts regulation database being stored within the blockchain-based data exchange storage and verification device.

6. The inspection system according to claim 1, wherein the repair reports generator comprises a set of software components for generating a repair report, the set of software components comprises:
a repair report controller, the repair report controller coordinates the interaction of the set of software components within the repair report generator;
a parts report data retriever, the parts report data retriever retrieves data from the blockchain-based data exchange storage and verification device containing inspection and parts identification data used and generated within the repair report generator;
a report compliance requirement processor, the report compliance requirement processor determines and provides all requirements associated with a repair report to be generated from the data associated with the repair and inspection data stored in the blockchain-based data exchange storage and verification device;
a repair report generator, the repair report generator receives repair report data obtained from the blockchain-based data exchange storage and verification device, and creates the repair report; and
a compliance report submitter, the compliance report submitter receives a completed and formatted repair report from the repair report generator with an identity of an agency server to which the completed and formatted repair report is to be submitted.

7. The inspection system according to claim 6, wherein the report compliance requirement processor is communicatively coupled to the parts compliance report database;
the parts compliance report database provides an identity of all required reports and any special requirements to be followed in generating the required reports; and
the repair reports database being stored within the blockchain-based data exchange storage and verification device.

8. The inspection system according to claim 6, wherein the repair report generator is communicatively coupled to a repair reports database;
the repair reports generator creates the repair report using a specified report format defined within an agency data record stored in the repair reports database that's associated with the agency server that is to receive the repair report;
the repair reports database creates the repair report using a specified report format defined within an agency data record stored in the repair reports database that's associated with the agency server that is to receive the repair report; and
the repair reports database being stored within the blockchain-based data exchange storage and verification device.

9. The inspection system according to claim 1, wherein the inspection system is used as part of a safety management system.

10. The inspection system according to claim 1, wherein the inspection system is used as part of a quality management system.

11. The inspection system according to claim 1, wherein the parts acquisition controller further comprises a payment processor for use is competing acquisition of replacement parts.

12. The inspection system according to claim 11, wherein the payment processor accepts as payment in a currency comprising fungible and non-fungible tokens, rights, crypto, stablecoin, social and online payment methods, digital wallet payment methods, credit cards, rewards, and data barter, with either zero gas fees and or micro and or custom transaction fees.
